(19) United States
(12) Patent Application Publication
(10) Pub. No.: US 2010/0322502 A1
(43) Pub. Date: Dec. 23, 2010

(54) MEDICAL DIAGNOSIS SUPPORT DEVICE, IMAGE PROCESSING METHOD, IMAGE PROCESSING PROGRAM, AND VIRTUAL MICROSCOPE SYSTEM

(75) Inventors: Takeshi OTSUKA, Tokyo (JP); Tatsuki YAMADA, Tokyo (JP); Yuichi ISHIKAWA, Tokyo (JP); Kengo TAKEUCHI, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignees: OLYMPUS CORPORATION, Tokyo (JP); JAPANESE FOUNDATION FOR CANCER RESEARCH, Tokyo (JP)

(21) Appl. No.: 12/816,472

(22) Filed: Jun. 16, 2010

(30) Foreign Application Priority Data
Jun. 18, 2009 (JP) JP 2009-145754
Apr. 30, 2010 (JP) JP 2010-105977

(51) Int. Cl. G06K 9/00

(52) U.S. Cl. 382/133

(57) ABSTRACT

The present invention provides a medical diagnosis support device, which is capable of acquiring information to support medical diagnosis for easily and precisely determining chromosome abnormality and/or gene amplification related to cancer or genetic disorder.

The medical diagnosis support device for acquiring information to support medical diagnosis from an image of a specimen stained by multiple staining, the image is obtained by photographing the stained specimen with transmitted light, the device comprises: staining characteristics quantity acquisition means for acquiring characteristics quantity of each staining, based on a pixel value of the image of the stained specimen; marker intensifying means for intensifying a marker, based on the characteristics quantity of each staining thus acquired; marker extracting means for extracting the marker of each staining, based on the characteristics quantity in which the marker has been thus intensified; marker state judging means for judging a state of the marker, based on the marker of each staining thus extracted; and marker state identifying and displaying means for identifying and displaying the marker state, based on the judgment result.

### CROSS-REFERENCE TO RELATED APPLICATION

The present application claims priority from Japanese Application No. 2009-145754, filed on Jun. 18, 2009, the content of which is incorporated herein by reference.

### BACKGROUND OF THE INVENTION

1. Field of the Invention

The present invention relates to a medical diagnosis support device, an image processing method, a image processing program and a virtual microscope system, for acquiring information to support medical diagnosis from a stained specimen image obtained by photographing a stained specimen.

2. Description of Related Art

Spectral transmittance spectrum is a physical quantity which represents a physical property inherent to a subject to be photographed. Spectral transmittance is a physical quantity which represents a ratio of transmitted light to incident light at a wavelength. Unlike color information such as RGB value which varies depending on changes in illumination light, the spectral transmittance is information which is inherent to the object and is not influenced by external factors. Thus, the spectral transmittance is used in various fields of application as information to reproduce colors of the subject itself For example, in the filed of pathological diagnosis using a living body tissue specimen, in particular, a pathological specimen, the spectral transmission is used for analysis of an image of a photographed specimen as an example of a spectrum characteristic value.

In order to analyze various possibilities of pathological diagnosis, a microscope is widely used to observe an enlarged view of a thin slice of several micron thickness, of a block specimen obtained from a removed organ and/or a pathological specimen obtained from needle aspiration biopsy. Above all, observation based on transmittance by using an optical microscope has been one of the most common observation methods because this method not only has a long history of application to observation but also only requires a device which is relatively cheap and easy to handle. In the case of this method, since a thinly sliced specimen fails to absorb or scatter the light and is almost colorless and transparent in its intact form, the specimen is generally stained with a dye before observation.

There have been proposed various types of staining techniques, of which number reaches more than 100. For a pathological specimen, in particular, hematoxilin-eosin staining protocol (which will be referred to as “HE staining” hereinafter) using hematoxylin as violet pigment and eosin as red pigment is utilized as a standard staining method.

Hematoxylin is a natural substance collected from plants, and it does not have stainability itself. However, hematin as an oxidized form of hematoxilin is a basophilic pigment and is readily bound to a negatively charged substance. Deoxyribonucleic acid (DNA) within a nucleus is negatively charged due to phosphate groups contained as components therein, and thus is bound to hematin and stained blue. Although stainability is exhibited by not hematoxilin but hematin as an oxidized form thereof, the term “hematoxilin” is generally used to refer to the pigment. The present application complies with this nomenclature practice and uses the term hematoxilin.

On the other hand, eosin is an acidiophilic dye that is bound to a positively charged substance. Whether amino acids and proteins are charged positive or negative depends on the environmental pH, and amino acids and proteins tend to be charged positive in an acidophilic environment. Thus, acetic acid is often added to the eosin solution. Proteins within cytoplasm is bound to eosin and thereby stained red or pale red.

HE stained specimen (stained sample) is easy to visualize, with nucleus or osseous tissues stained in violet, while cytoplasm, connective tissues, and red blood cells stained in red. As a result, observers can determine dimensions and positional relationships of components constituting a tissue such as a cell nucleus and thus judge the morphology of a specimen.

Besides being observed by naked eyes, stained specimen is observed by obtaining an image thereof by multiband photography and displaying the image on a display screen of an external device. In the case where an image is to be displayed on a display screen, there are carried out, for example, a process for estimating a spectrum transmittance at each point of the specimen from the photographed multiband image and a process for estimating a quantity of the pigment staining the specimen, based on the spectrum transmittance thus estimated, whereby a display image as a RGB image of the specimen, for display, is synthesized.

Examples of a method of estimating the spectral transmission at each point based on the multiband image of a specimen includes an estimation method by analysis of the main component, an estimation method by the Wiener estimation and the like. The Wiener estimation is one of a well known linear filtering method of estimating an original signal from an observed signal having the superimposed noise. Specifically, this estimation method is a technique to minimize an error by considering the statistical characteristics of an object being observed and the characteristics of noise (observed noise. Since a signal from a camera contains some kind of noise, the Weiner estimation is extremely useful as a method of estimating the original signal.

hereinafter, a conventional method to synthesize a display image from a multiband image of a specimen will be described.

First, a multiband image of a specimen is obtained from shooting. For example, a multiband image is obtained by shooting by the frame sequential method, while switching 16 bandpass filters by rotating them by a filter wheel. As a result, a multiband image having 16-band pixel values is obtained at each point of the specimen. Normally, pigments are three-dimensionally distributed in a specimen to be observed. However, these pigments cannot be captured as they are, as a three-dimensional image, in an ordinary observation system based on transmittance but observed as a two-dimensional image as a projection when illumination light transmitted through the specimen is projected onto an image pickup element of a camera. Accordingly, in the present specification, each “point” of a specimen represents a point on the specimen corresponding to each pixel of the image pickup element on which the illumination light is projected.

In the present invention, regarding an arbitrary point (pixel) x of the photographed multiband image, there exists a relationship expressed by formula (1) below, based on a response system of the camera, between a pixel value g(x, b) in a band b and a spectrum transmittance t(x, λ) at the corresponding point of the specimen.

g(x,b)=∫_{λ}f(b,λ)s(λ)e(λ)t(x,λ)dλ+n(b) (1)

In the formula (1), the characteristics represented by the parameters are as follows: λ as wavelength; f(b,λ) as a spectrum transmittance of the bₜₕ filter; s(λ) as spectrum sensitivity of the camera; e(λ) as spectral radiation characteristics of illumination; and n(b) as observation noise in band b. The symbol “b” represents a serial number to distinguish the band, and is an integer satisfying 1≦b≦16. In practical calculation, formula (2), which is obtained by discretizing formula (1) in the direction of a wavelength, is used.

G(x)=FSET(x)+N (2)

In formula (2), provided that the number of sample points in the direction of wavelength is D and the band number is B (here, B=16), then G (x) is a B×1 matrix corresponding to a pixel value g(x, b) at a point x. Similarly, T(x) is a D×1 matrix corresponding to t(x,λ), and F is a B×D matrix corresponding to f(b,λ). On the other hand, S corresponds to the diagonal matrix of D×D, with diagonal elements corresponding to s(λ). Similarly, E corresponds to a diagonal matrix of D×D, with diagonal elements corresponding to e(λ). N is a B×1 matrix corresponding to n(b). The formula (2) does not include the variable b representing the number of bands because plural formulae regarding bands are aggregated by using a matrix. Integration of a wavelength λ has been replaced with the product of the matrices.

Then, in order to simplify the formulae, a matrix H defined by following formula (3) is introduced. This matrix H is referred to as a system matrix.

H=FSE (3)

Accordingly, formula (3) can be replaced with the following formula (4).

G(x)=HT(x)+N (4)

Then, spectrum transmittance at each point of the specimen is estimated from the photographed multiband image by using the Weiner estimation. An estimated value of spectrum transmittance (data of spectrum transmittance) T̂(x) can be calculated using the following formula (5). “T̂” represents that T is accompanied by a symbol “̂” (hat), indicating that the matrix T is an estimated one.

\hat{T}(x)=WG(x) (6)

In the present invention, “W” is represented by following formula (6) and known as the “Weiner estimation matrix” or “an estimation operator used for Weiner estimation”.

W=RssH^{t}(HRₛₛH^{t}+R_{NN})⁻¹ (6)

wherein “( )^{t}” represents a transposed matrix and “( )⁻¹” represents an inverse matrix.

In formula (6), R_{SS} is a matrix of D×D, representing an autocorrelation matrix of the spectrum transmittance of a specimen. R_{NN} is a matrix of B×B, representing the autocorrelation matrix of noise of a camera for use in photographing an image.

The spectrum transmittance data T̂(x) can be calculated as described above. Then, the quantity of the pigment at the corresponding point on the specimen (the specimen point) is estimated, based on the T̂(x). The pigments subjected to the estimation are three types of pigments including hematoxylin, eosin which has stained cytoplasm, and eosin which has stained red blood cells or non-stained red blood cells themselves. They will be abbreviated as Pigment H, Pigment E, and Pigment R, respectively, hereinafter. Strictly speaking, red blood cells possess a color specific thereto in the non-stained state and, after HE staining, exhibit the color of themselves and the color of eosin which has been changed during the staining process in a superposed manner in observation. Due to this, precisely speaking, these colors observed in combination are referred to as Pigment R.

It is generally known that, in a light-transmittable substance, there exists the Lambert-Beer law expressed by following formula (7) between the intensity I₀(λ) of incident light and the intensity I(λ) of emitted light for every wavelength (λ).

$$\frac{I ( λ )}{{I}_{0} ( λ )} = {e}^{- k ( λ ) \cdot d} \qquad ( 7 )$$

In formula (7), k(λ) represents a value which is specific to the substance and depends on the wavelength, and d represents the thickness of the substance.

The left side of the formula (7) represents the spectrum transmittance t(λ). Accordingly, formula (7) can be converted into following formula (8).

t(λ)=e^{-k(λ)·d} (8)

In addition, spectrum absorbance a(λ) is represented by following formula (9).

a(λ)=k(λ)·d (9)

Accordingly, formula (8) can be replaced with the following formula (10).

t(λ)=e^{-a(λ)} (10)

In the present invention, in a case where the HE-stained specimen is stained with 3 different pigments, pigment H, pigment E, and pigment R, following formula (11) is satisfied at each wavelength by Beer-Lambert law.

$$\frac{I ( λ )}{{I}_{0} ( λ )} = {e}^{- ( {k}_{H} ( λ ) \cdot {d}_{H} + {k}_{E} ( λ ) \cdot {d}_{E} + {k}_{R} ( λ ) \cdot {d}_{R} )} \qquad ( 11 )$$

In formula (11), k_{H}(λ), k_{E}(λ), k_{R}(λ) represent k(λ) values corresponding to pigment H, pigment E, and pigment R, respectively. For example, k(λ) is color spectrum of each pigment staining the specimen (which will be referred to as “standard pigment spectrum” hereinafter). Further, d_{H}, d_{E}, and d_{R} respectively represent imaginary thickness values of pigment H, pigment E, and pigment R at each specimen point corresponding to each image position of the multiband image. Pigments exist in a dispersed manner in a specimen and thus the concept of thickness is not necessarily correct. The above d_{H}, d_{E}, and d_{R} respectively represent indices of relative pigment quantity indicating the amount of each pigment in a case where it is assumed that the specimen is stained with only one pigment. That is, d_{H}, d_{E}, and d_{R} represent the quantity of pigment in pigment H, pigment E, pigment R, respectively. The standard pigment spectra k_{H}(λ), k_{E}(λ) and k_{R}(λ) can be easily obtained by Lambert-Beer law by preparing in advance specimen individually stained with pigment H, pigment E, and pigment R, respectively, and measuring spectrum transmittance by a spectrometer.

In the present invention, provided that spectrum transmittance and spectrum absorbance at a position x are t(x,λ) and a(x,λ), respectively, formula (9) can be converted into following formula (12).

a(x,λ)=k_{H}(λ)·d_{H}+k_{E}(λ)·d_{E}+k_{R}(λ)·d_{R} (12)

Furthermore, provided that t̂(x,λ) represents estimated spectrum transmittance and â(x,λ) represents estimated absorbance at a wavelength λ of T̂(x,λ) estimated by using formula (5), the formula (12) can be converted into following formula (13). It should be noted that t̂ represents that t is accompanied by the symbol “̂” and â represents that a is accompanied by the symbol “̂”.

â(x,λ)=k_{H}(λ)·d_{H}+k_{E}(λ)·d_{E}+k_{R}(λ)·d_{R} (13)

In formula (13), since there are three unknown variables d_{H}, d_{E}, and d_{R}, solutions of these variables can be obtained if we have simultaneous equations thereof for at least three different wavelengths λ. It is acceptable to prepare simultaneous equations of formula (13) for at least four different wavelengths λ to enhance precision and perform multiple linear regression analysis. For example, in a case where simultaneous equations of formula (13) are prepared for three different wavelengths λ₁, λ₂, λ₃, these simultaneous equations can be expressed by matrixes as below.

$$( \begin{matrix}\hat{a} ( x , {λ}_{1} ) \\ \hat{a} ( x , {λ}_{2} ) \\ \hat{a} ( x , {λ}_{3} )\end{matrix} ) = ( \begin{matrix}{k}_{H} ( {λ}_{1} ) & {k}_{E} ( {λ}_{1} ) & {k}_{R} ( {λ}_{1} ) \\ {k}_{H} ( {λ}_{2} ) & {k}_{E} ( {λ}_{2} ) & {k}_{R} ( {λ}_{2} ) \\ {k}_{H} ( {λ}_{3} ) & {k}_{E} ( {λ}_{3} ) & {k}_{R} ( {λ}_{3} )\end{matrix} ) ( \begin{matrix}{d}_{H} \\ {d}_{E} \\ {d}_{R}\end{matrix} ) \qquad ( 14 )$$

Then, formula (14) is converted into formula (15).

Â(x)=Kd(x) (15)

In formula (15), provided that D represents the number of sample points in the wavelength direction, Â(x) represents a D×1 matrix corresponding to â(x,λ), K represents a D×3 matrix corresponding to k(λ), and d(x) represents a 3×1 matrix corresponding to d_{H}, d_{E}, and d_{R} at the point x. It should be noted that Â represents that A is accompanied by the symbol “̂”.

Then, the pigment quantities d_{H}, d_{E}, and d_{R} are calculated by using the least-squares analysis, according to formula (15). The least-squares analysis is a method of determining d(x) such that the sum of squares of errors is minimized in a simple linear regression formula and can be calculated by following formula (16). In formula (16), d̂(x) represents an estimated pigment quantity.

\hat{d}(x)=(K^{T}K)⁻¹K^{T}Â(x) (16)

Quantities of the respective pigments staining the specimen are estimated as described above. A RGB image as a display image of the specimen is then synthesized, based on the pigment quantities thus estimated.

As a pathological diagnosis method using pigment quantities, there has been known a method of staining a pathological specimen with two types of dyes and estimating quantities of the respective dyes from spectrum images, to judge presence/absence of cancer cells based on the ratio of one pigment quantity to another (e.g. JP 2001-525580). This pathological diagnosis method can be applied to detection of cancer cells in a case where the ratio of one pigment quantity to another pigment quantity clearly differs between cancer cell and normal cell. However, the HE staining is a dye which stains only nucleus and cytoplasm and does not specifically stain cancer cell. Therefore, it is necessary to apply another dye which specifically stains cancer cells.

Further, fluorescence in situ hybridization (FISH) is known as a method of detecting chromosome abnormality and/or gene amplification related to cancer or genetic disorder by fluorescent observation. In the FISH method, a marker is marked with a fluorescence substance or an enzyme, so that a targeted gene subjected to hybridization can be observed by a fluorescent microscope. Further, there is also known a method of separating an image for each staining, by unmixing, from a specimen stained with plural fluorescent colors, for observation (JP 2007-010340). A marker in the FISH method exhibits a stronger color by applying the observation method disclosed in JP 2007-010340 thereto, so that a marker in the image of each staining thus separated can be easily observed by eyes.

Yet further, there is know the chromogenic in situ hybridization (CISH) method as a method of detecting chromosome abnormality and/or gene amplification related to cancer or genetic disorder, as in FISH. The CISH method is a method of detecting a marker by an optical microscope according to the protocol of immunostaining or the like. The CISH method has following advantages, as compared with the FISH method.

(1) Marker and morphology can be observed simultaneously.
(2) Markers of CISH are very cheap and slides can be stored at the room temperature.
(3) CISH does not necessitate use of an expensive microscope.

### SUMMARY OF THE INVENTION

### Problems To Be Solved By the Invention

It has been conventionally difficult to carry out multiple staining with respect to the same one specimen by CISH. Therefore, FISH is generally used when observation is to be carried out with multiple staining. However, in recent years, there has been proposed Dual CISH staining in which dual staining is carried out in CISH. According to Dual CISH staining, it is possible to stain different markers with two different colors, for example, red and blue, respectively, and make a definitive diagnosis in view of whether the positions of the markers thus stained with different colors are located at the same site (normal) or distanced (translocation).

However, cytoplasm other than markers is stained by CISH staining, as compared with FISH staining. The degree of staining varies depending on respective cells and there may be a case where the staining density of cytoplasm in one densely stained cell is approximately equal to the staining density of a marker in another palely stained cell. Therefore, making judgment on a marker in CISH is more difficult in FISH. In the case of Dual CISH, in particular, since the two colors of multiple staining are mixed, markers for each staining cannot be easily identified and thus judgment on translocation cannot be made easily.

Due to the facts described above, in the field of pathological diagnosis, there has been a demand for developing a technique which enables easily and precisely determining chromosome abnormality and gene amplification related to cancer or genetic disorder by bright field-observation such as Dual CISH and thereby acquiring information to support medical diagnosis.

The present invention has been contrived to meet such a demand as described above. An object of the present invention is to provide a medical diagnosis support device, as well as an image processing method, an image processing program, and a virtual microscope system related thereto, which enable easily and precisely determining chromosome abnormality and gene amplification related to cancer or genetic disorder by bright field-observation of a specimen stained by multiple staining and thereby acquiring information to support medical diagnosis.

### Means For Solving the Problem

In order to solve the aforementioned object, the present invention provides a medical diagnosis support device for acquiring information to support medical diagnosis from an image of a specimen stained by multiple staining, the image is obtained by photographing the stained specimen with transmitted light, the device comprising: staining characteristics quantity acquisition means for acquiring characteristics quantity of each staining, based on a pixel value of the image of the stained specimen; marker intensifying means for intensifying a marker, based on the characteristics quantity of each staining acquired by the staining characteristics quantity acquisition means; marker extracting means for extracting the marker of each staining, based on the characteristics quantity in which the marker has been intensified by the marker intensifying means; marker state judging means for judging a state of the marker, based on the marker of each staining extracted by the marker extracting means; and marker state identifying and displaying means for identifying and displaying the marker state, based on the judgment result made by the marker state judging means.

Further, an image processing method of the present invention to achieve the aforementioned object is an image processing method for acquiring information to support medical diagnosis from an image of a specimen stained by multiple staining, the image is obtained by photographing the stained specimen with transmitted light, the method comprising the steps of: acquiring characteristics quantity of each staining, based on a pixel value of the image of the stained specimen; intensifying a marker, based on the characteristics quantity of each staining thus acquired; extracting the marker of each staining, based on the characteristics quantity in which the marker has been thus intensified; judging a state of the marker, based on the marker of each staining thus extracted; and identifying and displaying the marker state, based on the judgment result.

Yet further, an image processing program of the present invention to achieve the aforementioned object is an image processing program for acquiring information to support medical diagnosis from an image of a specimen stained by multiple staining, the image is obtained by photographing the stained specimen with transmitted light, the program making a computer execute the processes of: acquiring characteristics quantity of each staining, based on a pixel value of the image of the stained specimen; intensifying a marker, based on the characteristics quantity of each staining thus acquired; extracting the marker of each staining, based on the characteristics quantity in which the marker has been thus intensified; judging a state of the marker, based on the marker of each staining thus extracted; and identifying and displaying the marker state, based on the judgment result.

Yet further, a virtual microscope system of the present invention to achieve the aforementioned object is a virtual microscope system for acquiring information to support medical diagnosis from an image of a specimen stained by multiple staining, the system comprising: image acquiring means for acquiring an image of the stained specimen by photographing the stained specimen with transmitted light by using a microscope; staining characteristics quantity acquisition means for acquiring characteristics quantity of each staining, based on a pixel value of the image of the stained specimen acquired by the image acquiring means; marker intensifying means for intensifying a marker, based on the characteristics quantity of each staining acquired by the staining characteristics quantity acquisition means; marker extracting means for extracting the marker of each staining, based on the characteristics quantity in which the marker has been intensified by the marker intensifying means; marker state judging means for judging a state of the marker, based on the marker of each staining extracted by the marker extracting means; and marker state identifying and displaying means for identifying and displaying the marker state, based on the judgment result made by the marker state judging means.

Yet further, a medical diagnosis support device of the present invention to achieve the aforementioned object is a medical diagnosis support device for acquiring information to support medical diagnosis from an image of a specimen stained by multiple staining, the image is obtained by photographing the stained specimen with transmitted light, the device comprising: target region intensifying means for intensifying a marker and a cell, respectively, based on a pixel value of the image of the stained specimen; target region extracting means for extracting the marker and the cell intensified by the target region intensifying means; cell state judging means for judging a cell state of the cell extracted by the target region extracting means, based on the marker extracted by the target region extracting means; and cell state identifying and displaying means for identifying and displaying the cell state, based on the judgment result made by the cell state judging means.

Yet further, an image processing method of the present invention to achieve the aforementioned object is an image processing method of acquiring information to support medical diagnosis from an image of a specimen stained by multiple staining, the image is obtained by photographing the stained specimen with transmitted light, the method comprising the steps of: acquiring characteristics quantity of each staining, based on a pixel value of the image of the stained specimen; intensifying a cell, based on the characteristics quantity of each staining thus acquired; extracting the cell, based on the characteristics quantity in which the cell has been thus intensified; intensifying a marker, based on the characteristics quantity of each staining thus acquired; extracting the marker of each staining, based on the characteristics quantity in which the marker has been thus intensified; judging a cell state of the extracted cell, based on the extracted marker; and identifying and displaying the cell state, based on the judgment result.

Yet further, an image processing program of the present invention to achieve the aforementioned object is an image processing program for acquiring information to support medical diagnosis from an image of a specimen stained by multiple staining, the image is obtained by photographing the stained specimen with transmitted light, the program comprising the processes of: acquiring characteristics quantity of each staining, based on a pixel value of the image of the stained specimen; intensifying a marker and a cell, respectively, based on the characteristics quantity of each staining thus acquired; extracting the marker and the cell, respectively, based on the characteristics quantities thereof in which the marker and the cell have been intensified, respectively; judging a cell state of the extracted cell, based on the extracted marker; and identifying and displaying the cell state, based on the judgment result.

Yet further, a virtual microscope system of the present invention to achieve the aforementioned object is a virtual microscope system for acquiring information to support medical diagnosis from a specimen stained by multiple staining, the system comprising: image acquiring means for acquiring an image of the stained specimen by photographing the stained specimen with transmitted light by using a microscope; staining characteristics quantity acquisition means for acquiring characteristics quantity of each staining, based on a pixel value of the image of the stained specimen acquired by the image acquiring means; target region intensifying means for intensifying a marker and a cell, respectively, based on the characteristics quantity of each staining acquired by the staining characteristics quantity acquisition means; target region extracting means for extracting the marker and the cell, respectively, based on the characteristics quantities thereof in which the marker and the cell have been intensified by the target region marker intensifying means; cell state judging means for judging a cell state of the cell extracted by the target region extracting means, based on the marker extracted by the target region extracting means; and cell state identifying and displaying means for identifying and displaying the marker cell state, based on the judgment result made by the cell state judging means.

### Effect of the Invention

According to the present invention, in a case where respective cells are in different conditions, a user such as a doctor can easily confirm a marker by his/her eyes because only the marker is identified and displayed. Further, a user such as a doctor can easily confirm whether a marker state is positive/negative by his/her eyes because a positive marker state and a negative marker state can be easily determined, respectively. As a result, it is possible to easily and precisely determine chromosome abnormality and/or gene amplification related to cancer or genetic disease.

Further, according to the present invention, a user such as a doctor can easily confirm a cell by his/her eyes because a marker and a cell are each extracted in an intensified state, respectively, and a cell state of the extracted cell is identified and displayed, based on the extracted marker. Yet further, a user such as a doctor can easily confirm whether a cell state is positive/negative by his/her eyes because a positive cell state and a negative cell state are identified and displayed such that these two states can be easily determined, respectively. As a result, it is possible to easily and precisely determine chromosome abnormality and/or gene amplification related to cancer or genetic disease.

### BRIEF DESCRIPTION OF THE DRAWINGS

FIG. 1 is a block diagram showing a functional constitution of main parts of a medical diagnostics support device according to a first embodiment of the present invention.

FIG. 2 is a schematic view showing a structure of the main parts of the image acquiring portion shown in FIG. 1.

FIG. 3(a) is a view schematically showing an example of arrangement of color filters disposed in a RGB camera shown in FIG. 2.

FIG. 3(b) is a view schematically showing a pixel arrangement of respective RGB bands.

FIG. 4 is a view showing spectral sensitivity characteristics of the RGB camera shown in FIG. 2.

FIG. 5 is a view showing spectrum transmittance characteristics of one of optical filters constituting a filter portion shown in FIG. 2.

FIG. 6 is a view showing spectrum transmittance characteristics of the other of optical filters constituting a filter portion shown in FIG. 2.

FIG. 7 is a flowchart schematically showing operations in the medical diagnosis support device shown in FIG. 1.

FIGS. 8(a), 8(b) and 8(c) are diagrams each showing an example image for explaining a process of estimating a pigment quantity in FIG. 7.

FIG. 9 is a flowchart showing a process of intensifying a marker in FIG. 7.

FIGS. 10(a) and 10(b) are example images, in each of which a marker has been intensified by the process shown in FIG. 9.

FIGS. 11(a) and 11(b) are diagrams each showing an example image of a marker obtained by a process of extracting a marker in FIG. 7.

FIG. 12 is a flowchart showing an example of a process of judging a marker state in FIG. 7.

FIG. 13 is a diagram for explaining a process of calculating a distance between centers of gravity of two markers shown in FIG. 12.

FIG. 14 is a flowchart showing another example of a process of judging a marker state in FIG. 7.

FIG. 15 is a diagram for explaining an example of judgment by the judging process shown in FIG. 14.

FIG. 16 is a view showing a form of display mode of GUI, specified by an identification and display specifying portion shown in FIG. 1.

FIGS. 17(a) to 17(f) are diagrams each showing an identification and display form of a stained marker, provided by the medical diagnosis support device of FIG. 1.

FIGS. 18(a) and 18(b) are diagrams for explaining a method of calculating characteristics quantity between markers, performed by a medical diagnosis support device according to a second embodiment of the present invention.

FIG. 19 is a diagram for explaining a method of calculating characteristics quantity between markers, performed by a medical diagnosis support device according to a third embodiment of the present invention.

FIG. 20 is a view showing a structure of the main parts of a microscope device constituting a virtual microscope system according to a fourth embodiment of the present invention.

FIG. 21 is a view showing a structure of main parts of a host system shown in FIG. 20.

FIG. 22 is a block diagram showing a functional constitution of main parts of a medical diagnostics support device according to a fifth embodiment of the present invention.

FIG. 23 is a flowchart schematically showing operations in the medical diagnosis support device shown in FIG. 22.

FIGS. 24(a) to 24(c) are diagrams for explaining an example of a cell state judgment by the medical diagnosis support device shown in FIG. 22.

FIGS. 25(a) to (c) are diagrams each showing an identification and display form of a cell state, provided by the medical diagnosis support device shown in FIG. 22.

### DESCRIPTION OF THE PREFERRED EMBODIMENTS

A preferred embodiment of the present invention will be described in detail with reference to the drawings.

### First Embodiment

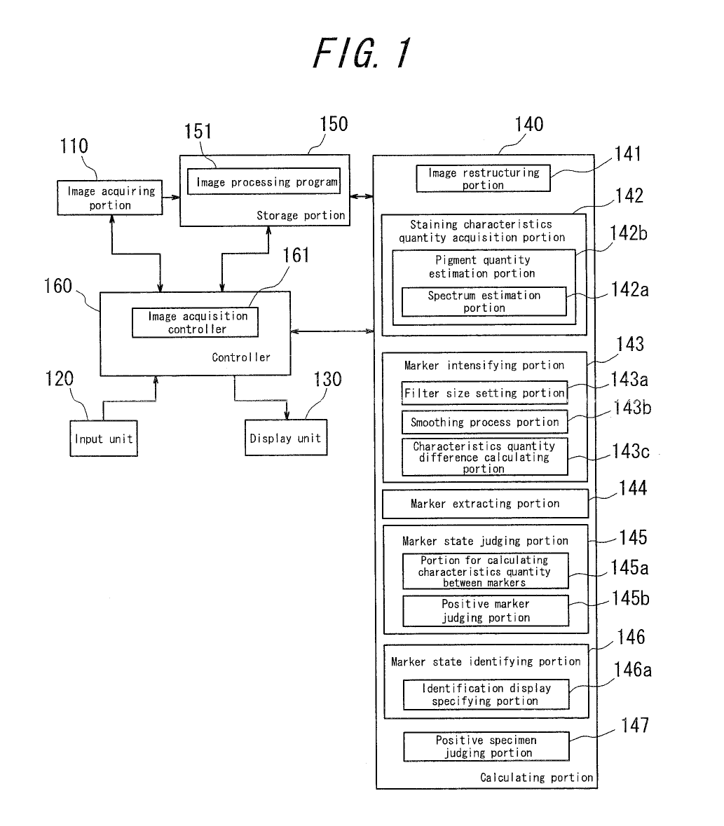

FIG. 1 is a block diagram showing a functional constitution of main parts of a medical diagnostics support device according to a first embodiment of the present invention. The medical diagnosis support device is structured to include a computer such as a personal computer and provided with an image acquiring portion 110 including a microscope, an input portion 120, a display portion 130, a calculation portion 140, a storage portion 150, and a controller 160 for controlling the respective portions.

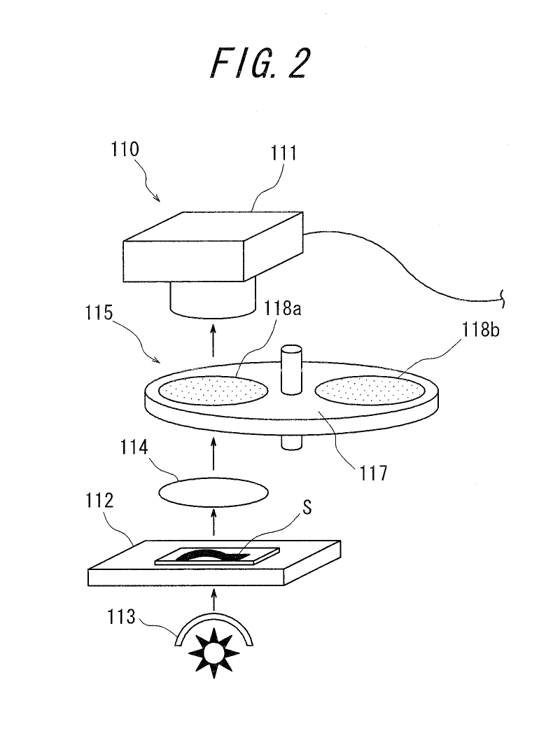

The image acquisition portion 110 acquires a multiband image (6 band image in the present embodiment) of a target stained specimen (which will be referred to as a “target specimen” hereinafter) by a microscope. FIG. 2 schematically shows a structure of main parts of the image acquisition portion 110. As shown in FIG. 2, the image acquisition portion 110 includes: a RGB camera 111 equipped with an image pickup element such as CCD (charge coupled devices) or CMOS (complementary metal oxide semiconductor); a specimen holding portion 112 on which a target specimen S is placed; an illumination portion 113 for illuminating the target specimen S on the specimen holding portion 112 by transmitted light; an optical system 114 including a microscope object lens for concentrating transmitted light from the target specimen S for imaging; and a filter portion 115 for restricting a wavelength range of light to be imaged to a predetermined range.

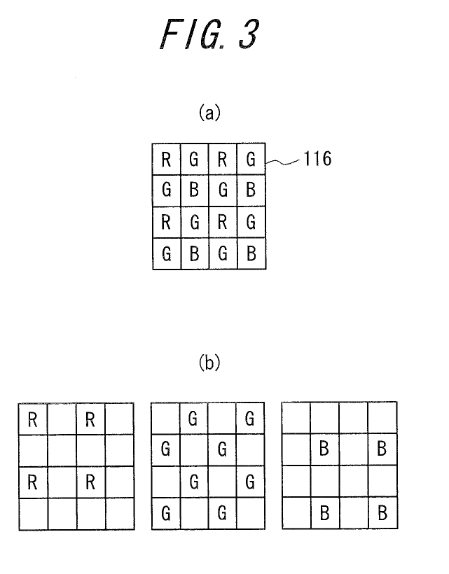

The RGB camera 111 is one which is widely used in, for example, a digital camera, of a single panel type on which a RGB color filter 116 of Bayer Arrangement as shown in FIG. 3(a) is disposed. The RGB camera 111 is disposed such that the center of an image to be photographed is located on the optical axis of illumination light. In the case of such a RGB camera 111 as described above, each pixel can photograph only one of the components R, G, B as shown in FIG. 3(b). However, insufficient R, G, B components are interpolated by utilizing other pixel values in the vicinity threreof. This technique is known in, for example, JP patent 3510037.

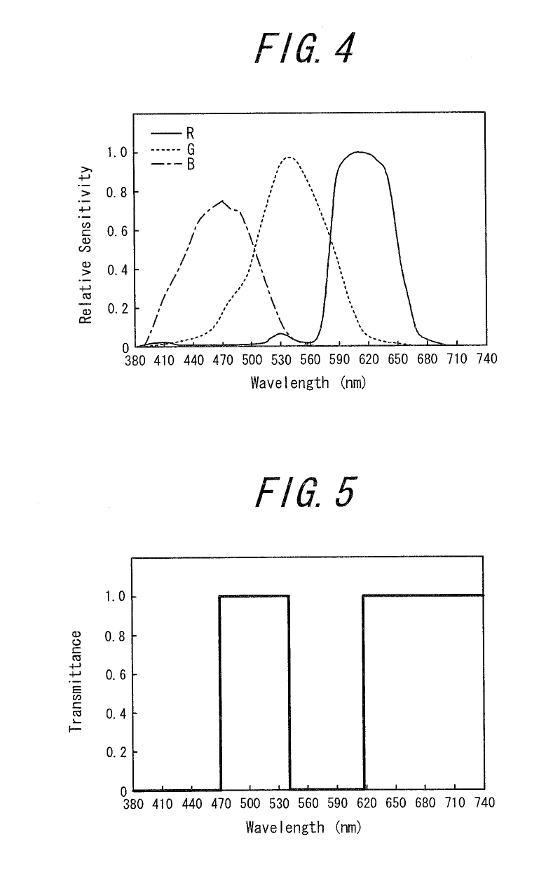

In a case where a RGB camera 111 of 3CCD (three-panel type) is used, the R, G, B components in each pixel can be acquired from the beginning. Either a single-panel or three-panel type camera may be used in the present embodiment. Hereinafter, it is assumed that respective R, G, B components have successfully been acquired in each pixel of an image photographed by the RGB camera 111. Further, it is assumed that the RGB camera 111 has spectral sensitivity characteristics of the respective R, G, B bands as shown in FIG. 4 when photographing is effected by illumination light propagating from the illumination portion 113 via the optical system 114.

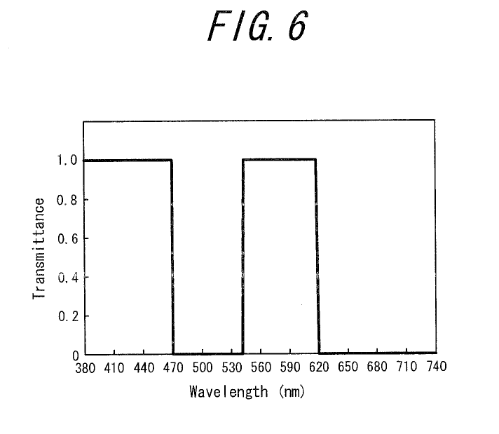

In the present embodiment, in order to acquire an image of 6 bands by using the RGB camera 111 having spectral sensitivity characteristics as shown in FIG. 4, the filter portion 115 is provided with a carousel filter switching portion 117 which holds two optical filters 118a, 118b having different spectrum transmittance characteristics such that these optical filters divide the transmitted wavelength region of each band of the components R,G, B into two. FIG. 5 shows the spectrum transmittance characteristics of one optical filter 118a, and FIG. 6 shows the spectrum transmittance characteristics of the other optical filter 118b.

The controller 116 at first causes, for example, the optical filter 118a to be positioned on the optical path extending from the illumination portion 113 to the RGB camera 111, the illumination portion 113 to illuminate the target specimen S placed on the specimen holding portion 112, and effects a first photographing by imaging the light transmitted via the optical system 114 and the optical filter 118a on an image pickup element of the RGB camera 111. Next, the controller 160 rotates the filter switching portion 117 such that the optical filter 118b is located on the optical path from the illumination portion 113 to the RGB camera 111, to effect a second photographing as in the first photographing.

As a result, images having three different bands are obtained from the first photographing and the second photographing, respectively, whereby multiband images having 6 bands are obtained. The number of the optical filter provided in the filter portion 115 is not limited to two and it is possible to obtain an image having a larger number of bands by using three or more optical filters.

The multiband image of the target specimen S acquired by the image acquisition portion 110 (which will be referred to as a “target specimen image” hereinafter) is stored as multiband image data in the storage portion 150.

The input portion 120 is realized by various input devices such as a keyboard, a mouse, a touch panel, switches and the like and outputs an input signal in accordance with an operation input to the controller 160.

The display portion 130 is realized by a display device such as a LCD (liquid crystal display) or EL (electro luminescence) display, a CRT (cathode ray tube) display or the like and displays various images, based on a display signal inputted from the controller 160.

The calculation portion 140 includes an image restructuring portion 141, a staining characteristics quantity acquisition portion 142, a marker intensifying portion 143, a marker extracting portion 144, a marker state judging portion 145, a marker state indentifying portion 146, and a positive specimen judging portion 147. The staining characteristics quantity acquisition portion 142 has a pigment quantity estimation portion 142b including a spectrum estimation portion 142a. The marker intensifying portion 143 has a filter size setting portion 143a, a smoothing process portion 143b, and a characteristic quantity difference calculation portion 143c. The marker state judging portion 145 has a portion 145a for calculating characteristics quantity between markers and a positive marker judging portion 145b. The marker state indentifying portion 146 has an identification and display specifying portion 146a. The calculation portion 140 is realized by a hard ware such as CPU.

The storage portion 150 is realized by: various IC memory like a memory-updatable flush memory such as ROM or RAM; an information storage medium such as a CD-ROM and a hard disc installed or connected by way of a data communication terminal; and an information storage medium reading device. An image processing program 151 for operating the medical diagnosis support device of the present embodiment to realize various functions provided in the medical diagnosis support device, data for use when the program is executed, and the like are stored in the storage portion 150.

The controller 160 sends instructions, carries out transfer of data, and the like, to the respective portions constituting the medical diagnosis support device, based on an input signal inputted from the input portion 120, image data inputted from the image acquisition portion 110, the program or data stored in the storage portion 150, and the like, to comprehensively control the entire operations. Further, the controller 160 has an image acquisition controller 161 for controlling operations of the image acquisition portion 110 and acquiring a target specimen image. The controller 160 is realized by a hardware such as CPU.

Hereinafter, operations of the medical diagnosis support device of the present embodiment will be described with reference to a case as an example where information to support medical diagnosis is obtained by multiband-photographing a specimen stained red (R) and blue (B) by Dual CISH. The processes described in this example are realized by operations of the respective portions of the medical diagnosis support device in accordance with the image processing program 151 stored in the storage portion 150.

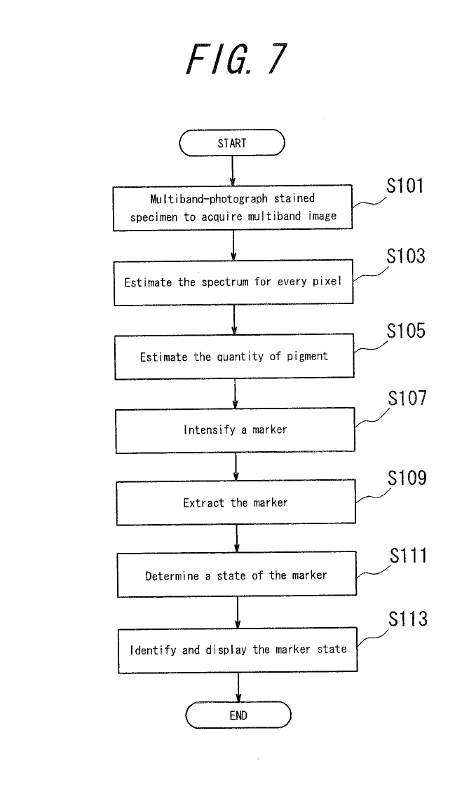

FIG. 7 is a flowchart schematically showing operations in the medical diagnosis support device of the present embodiment. First, the controller 160 controls operations of the image acquisition portion 110 by the image acquisition controller 161 to multiband-photograph a target specimen S, whereby target specimen images for the respective bands are acquired (step S101). The image data of these target specimen images is stored in the storage portion 150.

In the present embodiment, a target specimen image of each band is acquired by restructuring plural images thereof photographed at different depths. Accordingly, in FIG. 2, the target specimen S is multiband-photographed at various depths by changing the focusing position, i.e. depth, effected by the optical system 114 with respect to the target specimen S, so that a set of image data obtained at different depth is stored in the storage portion 150. The depth at which multiband photography is focused is changed by 1 μm as unit because the diameter of a cell nucleus is in the range of 5 to 10 μm.

Then, a target specimen image for each band is acquired, by the image restructuring portion 141, by restructuring based on the image data of plural images focused at different depths, stored in the storage portion 150. The image restructuring portion 141 restructures the images by either making the focal points of the plural data images focused at different depths coincide with each other at respective regions (see, for example, JP 2005-037902) or averaging the plural data images at different depths.

Since multiband images of a target specimen S are photographed at different focal depth and a target specimen image for each band is acquired by restructuring based on the plural data images at different focal depths, it is possible to obtain an image in which cell nucleus at different focal depth is well reflected.

After acquiring a target specimen image for each band, the controller 160 then acquires by the staining characteristics quantity acquisition portion 142 characteristics quantity of each staining at each pixel of the target specimen image for each band, to produce a separate image for each staining (a separate staining image) based on the characteristics quantity. In the present embodiment, examples of the characteristics quantity of each staining include: (1) pigment quantity of each staining; (2) a pixel value of any optional band, i.e. a pixel value of a stained specimen image photographed with illumination light in any optional wavelength range; (3) characteristics quantity of an image converted by any optional mathematical formula regarding, e.g. hue; and (4) characteristics quantity calculated by linear unmixing. Any of the characteristics quantities above may be acquired. In the present embodiment, the pigment quantity of above (1) is acquired as the characteristics quantity of each staining. Hereinafter, there will be described a process of estimating spectrum from a pixel value and then estimate pigment quantity of each staining from the spectrum to produce a separate staining image based on the pigment quantity.

First, spectrum (spectrum transmittance) of the target specimen is estimated by the spectrum estimation portion 142a, based on the pixel value of the target specimen image acquired at step S101 (step S103). Then, from a matrix expression G(x) of a pixel value of a pixel at an arbitrary point x as an estimation target pixel of the target specimen image, an estimated value T̂(x) of the spectrum transmittance at a corresponding specimen point of the target specimen is estimated. The estimated value T̂(x) of the spectrum transmittance thus obtained is stored in the storage portion 150.

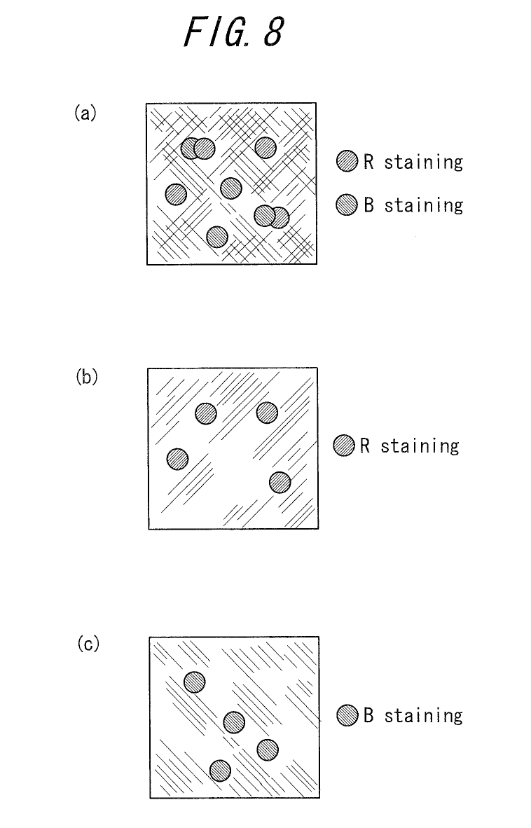

Next, pigment quantity of the target specimen is estimated by the pigment quantity estimation portion 142b, based on the estimated value T̂(x) of spectrum transmittance estimated at step S103 (step S105). In the present embodiment, the pigment quantity estimation portion 142b estimates the pigment quantity resulted from each staining method at the specimen point corresponding to each arbitrary point x of the target specimen image, based on the standard spectrum characteristics of each pigment of the staining method used for staining the target specimen. Specifically, based on the respective estimated values T̂(x) of spectrum transmittance at arbitrary points x of the target specimen image, respective pigment quantities fixed at the specimen points of the target specimen, corresponding to the points x, are estimated. Specifically, solutions of d̂_{R} and d̂_{B} are obtained according to formula (16) described above. The pigment quantities d̂_{R}, d̂_{B} at the point x of the target specimen image thus estimated are stored in the storage portion 150. As a result, for example, from an original image as shown in FIG. 8(a), an image of the pigment quantity d̂_{R} as shown in FIG. 8(b) and an image of the pigment quantity d̂_{B} as shown in FIG. 8(c) are obtained, respectively. It should be noted that FIGS. 8(a) to 8(c) are sample images and the diagonal lines rising toward the right hand-side in the background represents a pale red-colored portion and the diagonal lines declining toward the right hand-side in the background represents a pale blue-colored portion.

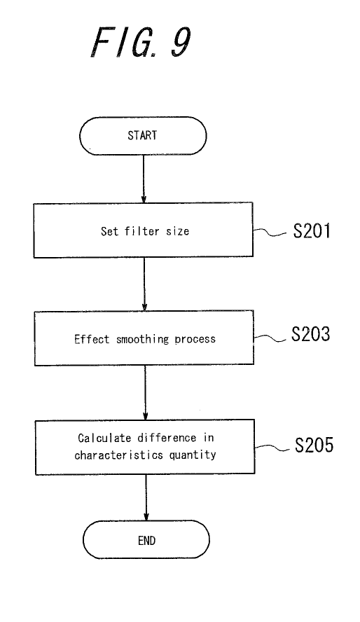

When a separate staining image has been produced by acquiring the characteristics quantity of each staining, then a marker in each separate staining image is intensified by the marker intensifying portion 143, based on the characteristics quantity or the pigment quantity of each staining estimated at step S105 (step S107). Hereinafter, with reference to the flowchart in FIG. 9, a process in a case where a marker is intensified will be described based on the characteristics quantity of staining at a target pixel and the characteristics quantity of staining at a pixel in the vicinity thereof.

First, two different filter sizes are set by the filter size setting portion 143a (step S201). In the present embodiment, the size of one filter is set to only correspond to the target pixel, while the size of the other filter is set to be the same size as the marker. Next, a smoothing process is carried out with respect to the characteristics quantity of staining by the smoothing process portion 143b by using the two filter sizes, respectively (step S203). The smoothing process may use any of Gaussian filter, median filter, mean filter and low pass filter. Thereafter, difference between the two characteristics quantities calculated by the smoothing process is calculated by the characteristics quantity difference calculation portion 143c (step S205).

In the present embodiment, when the smoothing process is carried out by using the filter of relatively large size, variation in staining due to the structure inside a cell is smoothed, whereby the characteristics quantity values indicating variation in staining between respective cells are calculated. In contrast, when the smoothing process is carried out by using the filter of relatively small size, the characteristics quantity values including both of variation in staining due to the structure inside a cell and variation in staining due to difference between respective cells are calculated. Further, sensor noise due to the image pickup element of the RGB camera 111 is also reduced by the smoothing effect caused by the two filters. Accordingly, variation in staining due to the structure inside a cell, that is, only a marker as the desired edge can be intensified by obtaining difference in characteristics quantity between the two filters by the characteristics quantity difference calculating portion 143c.

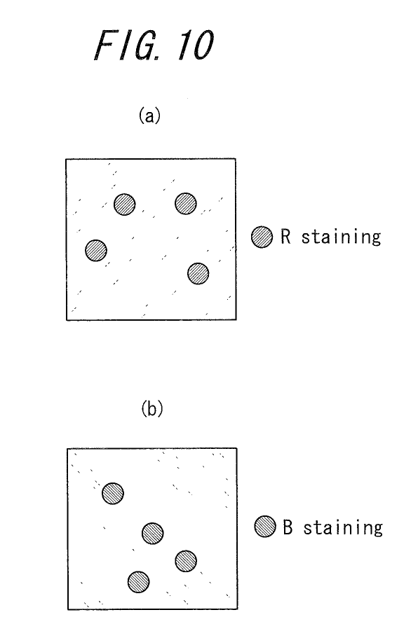

The sizes of the two different filters are appropriately set by the filter size setting portion 143a by way of the input portion 120 such that only a marker is intensified, as described above. Since the marker changes the size thereof in an image, depending on a magnification rate of the microscope, the size of at least one of the filters is adjusted in an appropriate manner in accordance with the magnification rate of the microscope. Difference between the two characteristics quantities calculated by the characteristics quantity difference calculating portion 143c is stored as a characteristics quantity in which the marker has been intensified (the pigment quantity) in the storage portion 150. As a result, an image of the pigment quantity d̂_{R} in which the red-tinted portion in the background is weakened and the marker has been intensified is obtained as shown in FIG. 10(a), and an image of the pigment quantity d̂_{B} in which the blue-tinted portion in the background is weakened and the marker has been intensified is obtained as shown in FIG. 10(b). FIG. 10(a) is a sample image corresponding to FIG. 8(b), and FIG. 10(b) is a sample image corresponding to FIG. 8(c).

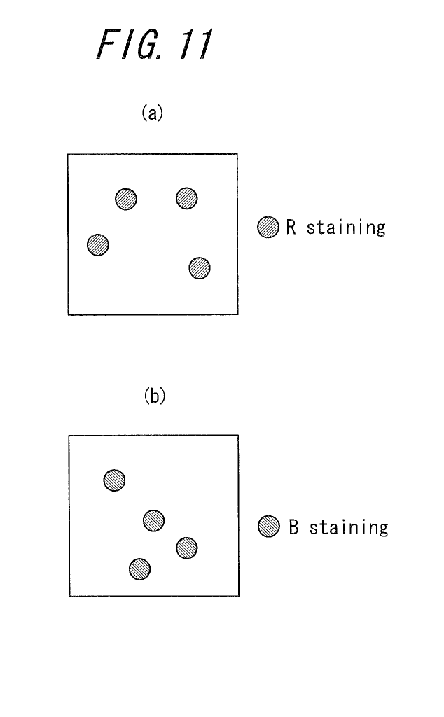

In FIG. 7, after the marker intensifying process by step S107 is completed, the marker of each staining is then extracted by the marker extraction portion 144, based on the characteristics quantity in which the marker has been intensified (step S109). In the present embodiment, the marker is extracted from each separate staining image by using a predetermined threshold value (a first threshold value) for each staining, based on comparison of the corresponding first threshold with the characteristics quantity. The marker data extracted from the marker extracting portion 144 is stored in the storage portion 150. As a result, a marker image based on the pigment quantity d̂_{R} as shown in FIG. 11(a) and a marker image based on the pigment quantity d̂_{B} as shown in FIG. 11(b) are obtained. FIG. 11(a) is a sample image corresponding to FIG. 10(a), and FIG. 11(b) is a sample image corresponding to FIG. 10(b).

In the present embodiment, the first threshold value for each staining for use in extracting the marker is either fixedly set regardless of the staining condition of a specimen or flexibly set by an any algorithm in accordance with the staining state of a specimen. In a case where the first threshold value is flexibly set by an algorithm, calculation is made by using, for example, K-means as a simple technique of non-hierarchical Clustering. K-means employs the average of a cluster and effects classification into given K clusters (K is a natural number). K-means is generally carried out according to a flow described below.

(1) It is set that the number of data is n and the number of clusters is K.
(2) The clusters are assigned at random to respective data.
(3) The center of each cluster is calculated, based on the assigned data. The average of respective elements of the assigned data is generally used for calculation.
(4) The distances between each data and the respective centers of the clusters are obtained and then the data is re-assigned to the cluster of which center is the closest thereto.
(5) The process is completed when no assignment of data to a cluster is changed. Otherwise, centers of the respective clusters are recalculated from the newly assigned clusters and the aforementioned process is repeated.

Since the result of K-means heavily depends on the initial random assignment of clusters, it is acceptable, for example, to evenly divide the range between the minimum value and the maximum value of the characteristics quantity and assign the clusters thereto. The result can then always be converged on equivalent values. The average of one of the clusters is selected as a threshold value. How many clusters to be used and which cluster's average value is to be selected as a threshold value are appropriately set as desired. An appropriate threshold value in accordance with the staining state of a specimen is set as described above.

After the marker of each staining is extracted, a marker state is then judged by the marker state judging means 145 (step S111). In this marker state judging process, first of all, the portion 145a for calculating characteristics quantity between markers calculates characteristics quantity between markers of different stainings from the marker data of each staining in a state where the respective separate staining images are superposed or overlaid (synthesized). In the present invention, distance between centers of gravity of two different markers is used as the characteristics quantity between these markers.

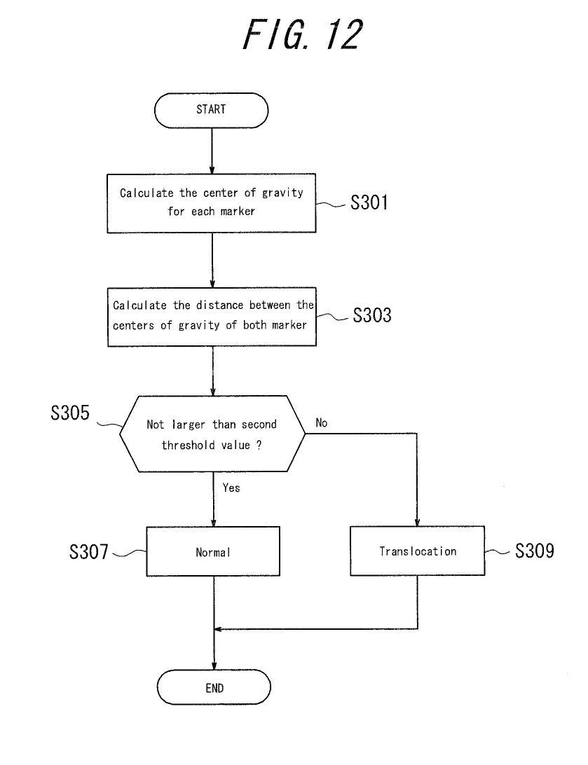

Hereinafter, one example of the marker state judging process using distance between centers of gravity of two different markers will be described with reference to a flowchart shown in FIG. 12. First, the center of gravity of each marker is obtained by formula (17) below (step S301).

$${center}_{i} ( x , y ) = ( \frac{{\sum }_{x} {\sum }_{y} x}{{\sum }_{x} {\sum }_{y} I} , \frac{{\sum }_{x} {\sum }_{y} y}{{\sum }_{x} {\sum }_{y} I} ) \qquad ( 17 )$$

wherein “centerₙ(x, y)” represents the center of gravity of marker I.

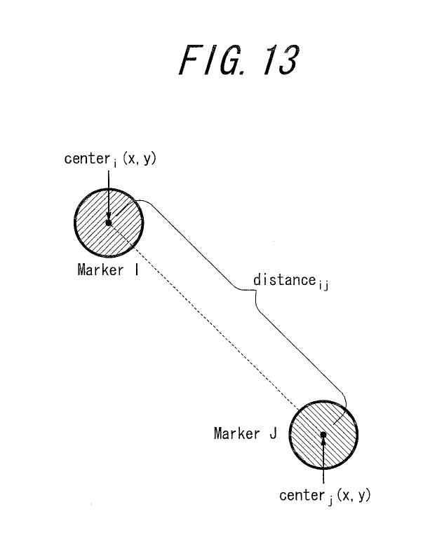

Next, distance between the center of gravity of two different markers is obtained by formula (18) below (step S303). FIG. 13 shows one example of “distanceᵢⱼ”, which is the distance between the centers of gravity of markers I, J calculated by formula (18).

$${distance}_{ij} = \sqrt{{( {center}_{i} ( x ) - {center}_{j} ( x ) )}^{2} + {( {center}_{i} ( y ) - {center}_{j} ( y ) )}^{2}} \qquad ( 18 )$$

Thereafter, the marker state judging portion 145 judges a marker state, based on the distance between the centers of gravity of the two markers. For this purpose, the distance between the centers of gravity of the two markers is compared with, for example, a predetermined threshold (a second threshold) (step S305). In a case where the distance is not larger than the second threshold value, it is judged that the pair of the markers is normal (step S307). In contrast, in a case where the distance between the center of gravity of any one marker in one staining and the center of gravity of every marker in the other staining fails to meet the second threshold value, i.e. exceeds the second threshold value, it is judged that the one marker is translocation (step S309). As a result, every marker is judged to be either in a normal state where two markers constitute a marker pair or in a translocation state where the marker exists solely. Since the distance between the centers of gravity of the two markers in an image changes depending on a magnification rate of the microscope, the second threshold value is appropriately adjusted, for example, by formula (19) below in accordance with the magnification rate of the microscope.

$${distance}_{threshold} ( scale ) = {distance}_{threshold} ( \times 10 ) \cdot \frac{scale}{10} \qquad ( 19 )$$

wherein “scale” represents a magnification rate of a microscope and “distance_{threshold}(scale)” represents a threshold value of the distance between the centers of gravity at the magnification rate “scale”.

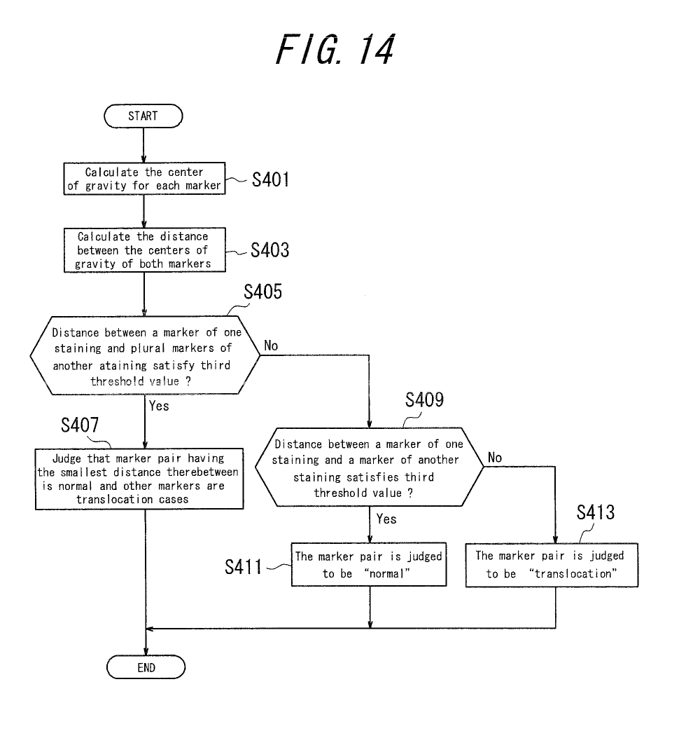

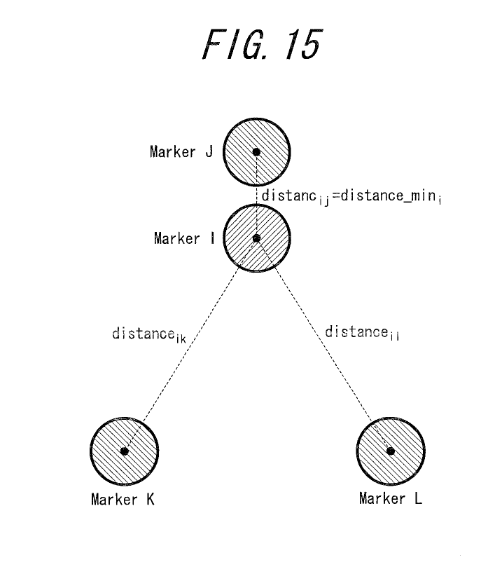

The marker state judgment process using distance between the centers of gravity of two markers can be carried out not only as shown in FIG. 12 but also according to the flowchart shown in FIG. 14. In FIG. 14, the steps from calculation of the center of gravity of each marker (step S401) to obtaining the distance between the centers of gravity of the two markers (step S403) are the same as the steps S301 to S303 in FIG. 12. Thereafter, the marker state judging portion 145 judges, for example, whether or not the distance between the center of gravity of any one marker in one staining and the center of gravity of each of at least two markers in the other staining meets a third threshold value (step S405). In a case where the distance meets the third threshold value (“Yes”), the marker pair having the smallest distance between the centers of gravity of two markers is judged to be normal according to formula (20) below, and other markers are judged to be a translocation case (step S407). FIG. 15 is a diagram for explaining a judgment example in the aforementioned cases. In FIG. 15, when the distance between the centers of gravity of markers I, J “distanceᵢⱼ”, the distance between the centers of gravity of the two markers I, K “distanceᵢₖ”, and the distance between the centers of gravity of the two markers I, L “distanceᵢₗ” meet the third threshold value, respectively, the pair of markers I, J having the smallest distance between the centers of gravity is judged to be normal and other markers K, L are judged to be translocations.

$${distance\_min}_{i} = min ( \sqrt{\begin{matrix}{( {center}_{i} ( x ) - {center}_{j} ( x ) )}^{2} + \\ {( {center}_{i} ( y ) - {center}_{j} ( y ) )}^{2}\end{matrix}} ) \qquad ( 20 )$$

wherein j=0, . . . n, and “distance_minᵢ” represents the minimum value of the distance between the centers of gravity in marker I.

In contrast, in a case where the distance between the center of gravity of any one marker in one staining and the center of gravity of each of at least two markers in the other staining fails to meet a third threshold value (“No”) at step S405, it is judged whether or not the distance between the center of gravity of the one marker in one staining and the center of gravity of one marker in the other staining meets a third threshold value (step S409). When the answer is “Yes” at step S409, the marker pair is judged to be normal as in the aforementioned judging process (step S411). In contrast, in a case where the distance between the center of gravity of any one marker in one staining and the center of gravity of every marker in the other staining fails to meet a third threshold value, the one marker of the one staining is judged to be a translocation case (step S413). As a result, every marker is judged to be either in a normal state where two markers constitute a marker pair or in a translocation state where the marker exists solely, as in the judgment process described above. Since the distance between the centers of gravity of the two markers in an image changes depending on a magnification rate of the microscope, the third threshold value is appropriately adjusted, for example, by formula (19) above in accordance with the magnification rate of the microscope. The third threshold value may be the same value as the second threshold value in the aforementioned judgment process.

In FIG. 7, the judgment result of a marker state, which has been made as described above, is stored in the storage portion 150 by step S111. Thereafter, the positive marker judging portion 145b judges, based on the judging result of the marker state, that the normal state case where two markers constitute a marker pair is negative and the translocation state case where only one marker exists solely is positive and stores the positive judgment result in the storage portion 150.

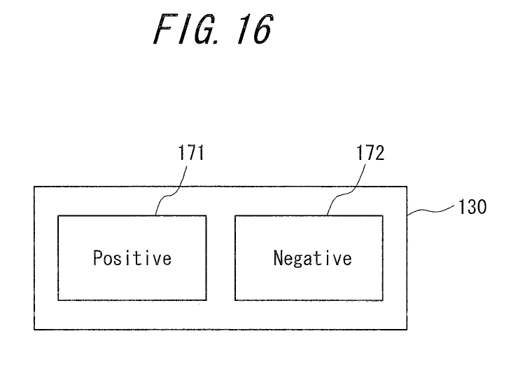

After the judgment process by the marker state judging portion 145 is completed as described above, the marker state is then identified by, for example, a primary color, a pattern, texture or a semitransparent color characteristically representing the staining and displayed in the display portion 130 by the marker state identifying portion 146 in accordance with a display mode specified by the identification display specifying portion 146a (step S113). Accordingly, in the present embodiment, the marker state identifying portion 146 and the display portion 130 constitute the marker state identifying and displaying means. When the display mode is specified by the identification display specifying portion 146a, for example, “positive” button 171 and “negative” button 172 using graphical user interface (GUI) are displayed at the display 130 by the controller 160, as shown in FIG. 16, so that a user can select the desired button via the input portion 120.

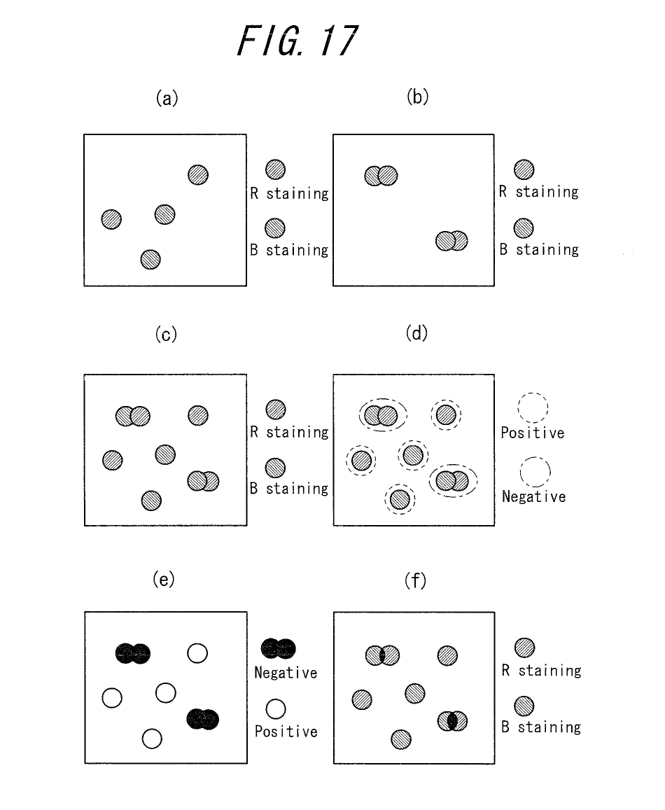

Then, for example, in a case where the “positive” button 171 has been selected, the positive display mode is specified and only positive markers are identified and displayed, as shown in FIG. 17(a). In a case where the “negative” button 172 has been selected, the negative display mode is specified and only negative markers are identified and displayed, as shown in FIG. 17(b). In a case where both the “positive” button 171 and the “negative” button 172 have been selected, the “all display” mode is specified and both of the positive marker and the negative marker pair are identified and displayed, as shown in FIG. 17(c).

In the case of the “all display” mode as shown in FIG. 17(c), it is acceptable to display the positive marker and the negative marker pair such that the former and the latter are encircled by, for example, different color broken lines, respectively, as shown in FIG. 17(d). Alternatively, the positive marker and the negative marker pair may be displayed such that the former and the latter are identified with different colors, respectively, as shown in FIG. 17(e). For example, respective positive markers of the two stainings may be displayed both in red color (blank white in FIG. 17(e)) and the two markers of the negative marker pair may be displayed both in blue color (black in FIG. 17(e)).

Further, for example, in a case where positive judgment of a target specimen S is carried out as described above, the superposed or overlaid portion of the marker pair may be displayed with a different color, as shown in FIG. 17(f). For instance, a marker by one staining is displayed with blue color, a marker by the other staining is displayed with red color, and the superposed portion of the markers of the two stainings is displayed with green color (black in FIG. 17(f)).

Thereafter, the positive specimen judging portion 147 judges whether the target specimen S is positive or negative. In this positive specimen judgment, for example, proportions of the positive marker pair and the negative markers judged by the marker state judging portion 145 are calculated by formula (21) below.

$$positive\_rate = \frac{{\sum }_{i} translocation ( i )}{{\sum }_{i} I} \qquad ( 21 )$$

wherein “positive_rate” represents a positive degree of the specimen and “translocation(i)” represents whether marker I is positive or not. Further, “translocation(i) is 1 in a positive case and zero in a negative case.

Alternatively, among the pixels of all the markers of each staining extracted by the marker extracting portion 144, the proportion of pixels superposed on those of the markers of the other staining is calculated by following formula (22).

$$positive\_rate = \frac{{\sum }_{i} {\sum }_{x} {\sum }_{y} overlay ( i , x , y )}{{\sum }_{i} {\sum }_{x} {\sum }_{y} I} \qquad ( 22 )$$

wherein “positive_rate” represents a positive degree of the specimen and “overlay(i, x, y)” represents whether the pixels of marker I are subjected to superposition. Further, “overlay(i, x, y) is 1 in a superposition case and zero in a non-superposition case.

Then, whether the target specimen S is positive or not is judged, based on comparison of the positive degree of the specimen calculated by formula (21) or formula (22) with a predetermined threshold, and the result is stored in the storage portion 150. Alternatively, the aforementioned positive degree of the specimen may be stored in the storage portion 150, as it is, as a reference value indicating the disease state of the specimen S.

According to the medical diagnosis support device of the present embodiment, a user such as a doctor can easily confirm markers by his/her eyes because only the markers stained by Dual CISH are identified and displayed if respective cells suffer from variation. Further, a user such as a doctor can easily confirm by his/her eyes whether the marker state is positive or negative because a test result is identified and displayed such that a positive marker state and a negative marker state can be easily distinguished. As a result, it is possible to easily and precisely determine chromosome abnormality and/or gene amplification related to cancer or genetic disease.

In the aforementioned embodiment, target specimen images of respective bands are acquired by restructuring by the image restructuring portion 141 based on plural sheets of image data obtained by multiband-photographing the target specimen S at different depths. However, it is acceptable to eliminate the image restructuring portion 141 and acquire target specimen images of respective bands by multiband-photographing the target specimen S at a predetermined depth.

Further, although the marker intensifying portion 143 effects the marker intensifying process by calculating difference between two characteristics quantities which have been smoothed, respectively, by using two different filter sizes, the marker may be intensified by an edge intensifying process. in the case of the edge intensifying process, an edge intensifying process is carried out on the characteristics quantity of staining by using one filter size. As a result, characteristics quantity in which only variation in staining due to the structures inside cells, i.e. markers, has been intensified is obtained and stored in the storage portion 150. The filter for use in this edge intensifying process may be any of Sobel filter, Laplacian filter and High-pass filter. The filter size is to be appropriately set to intensify a marker. In the case of intensifying a marker by the edge intensifying process, it is still desirable to appropriately adjust a filter size in accordance with a magnification rate of the microscope.

The marker extraction portion 144 may extract only a marker from the marker data not by K-means but, alternatively, by morphological analysis. For example, circularity and/or area indicating morphology of a marker is calculated for each particle of the marker image and the circularity and/or area thus calculated is compared with a predetermined threshold value, whereby only the marker is extracted through filtering. As a result, a particle or the like, derived from an edge of non-circular cytoplasm mistakenly intensified as a marker, can be extracted.

Further, although the positive specimen judging portion 147 judges whether a target specimen S is positive or not based on the judging result of a marker state made by the marker state judging portion 145 in the aforementioned embodiment, it is acceptable to eliminate the positive specimen judging portion 147 and simply indentify and display the marker state.

### Second Embodiment

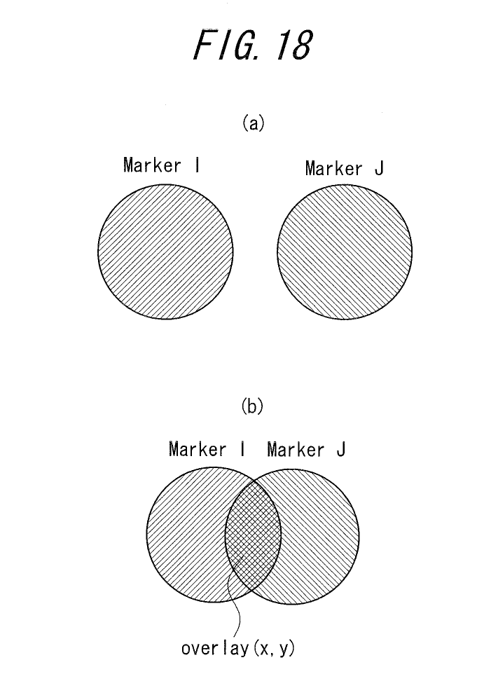

The medical diagnosis support device according to a second embodiment of the present invention differs from the aforementioned first embodiment in that the former employs as characteristics quantity between markers a ratio of an area where markers of respective stainings are superposed on each other, with respect to an area of a marker where no such superposition is observed, in judging a maker state at step S111 in FIG. 7. Specifically, there is employed a ratio of an area where marker I and marker J are superposed on each other as shown in FIG. 18(b) with respect to an area of marker I or marker J as shown in FIG. 18(a). A normal or translocation state is then determined based on comparison of the area ratio with a predetermined threshold value, as described above.

The aforementioned area ratio can be obtained by following formula (23). In formula (23), overlay_rateᵢ represents a superposed area ratio of marker I and overlay(x, y) represents whether the pixels are superposed or not, wherein overlay(x, y) is 1 when superposition is observed and zero when no superposition is observed. Since other structures and operations are the same as those in the first embodiment, detailed descriptions thereof will be omitted.

$${overlay\_rate}_{i} = \frac{{\sum }_{x} {\sum }_{y} overlay ( x , y )}{{\sum }_{x} {\sum }_{y} I} \qquad ( 23 )$$

By employing a ratio of a superposed area with respect to a non-superposed area of a marker of each staining, as described above, there can be obtained an effect similar to that of the first embodiment.

### Third Embodiment

The medical diagnosis support device according to a third embodiment of the present invention differs from the aforementioned first embodiment in that the former carries out the steps S103 to S109 in FIG. 7, based on multiband images of a target specimen S at respective depths acquired by the image acquisition portion 110, to extract a marker of each staining at the respective depths.

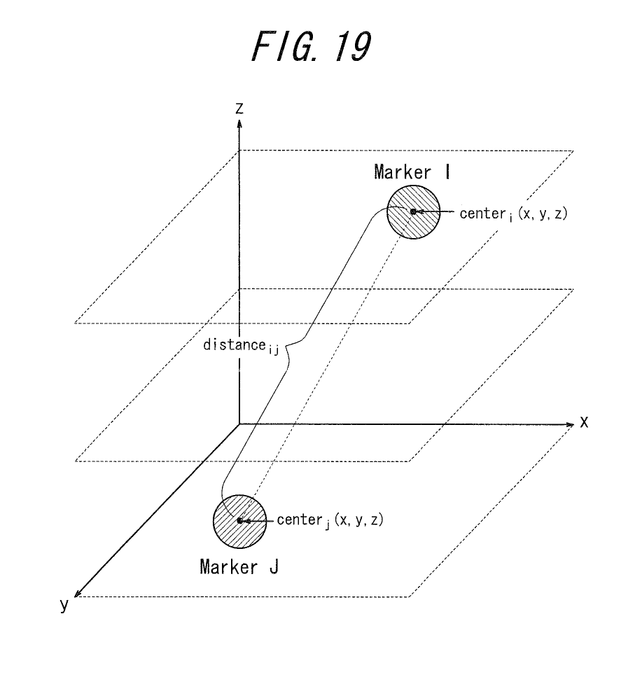

Thereafter, in step S111 of FIG. 7, the distance between the centers of gravity of two different markers at different depths is calculated as characteristics quantity between the markers by following formula (24), so that a normal or translocation marker state can be determined based on comparison of the distance between the centers of gravity thus calculated and a predetermined threshold value, as described above. FIG. 19 shows an example of “distanceᵢⱼ” as the distance between the centers of gravity of markers I, J at different depths (in z direction) calculated by formula (24). Since other structures and operations are the same as those in the first embodiment, detailed descriptions thereof will be omitted.

$${distance}_{ij} = \sqrt{\begin{matrix}{( {center}_{i} ( x ) - {center}_{j} ( x ) )}^{2} + \\ {( {center}_{i} ( y ) - {center}_{j} ( y ) )}^{2} + \\ {( {center}_{i} ( z ) - {center}_{j} ( z ) )}^{2}\end{matrix}} \qquad ( 24 )$$

By employing distance between centers of gravity of two markers having different depths as characteristics quantity between the markers, an effect similar to that in the first embodiment can be obtained. Further, since the distance in the z direction is also considered, there can be obtained an effect of calculating distance between centers of gravity according to the actual three-dimensional space.

### Fourth Embodiment

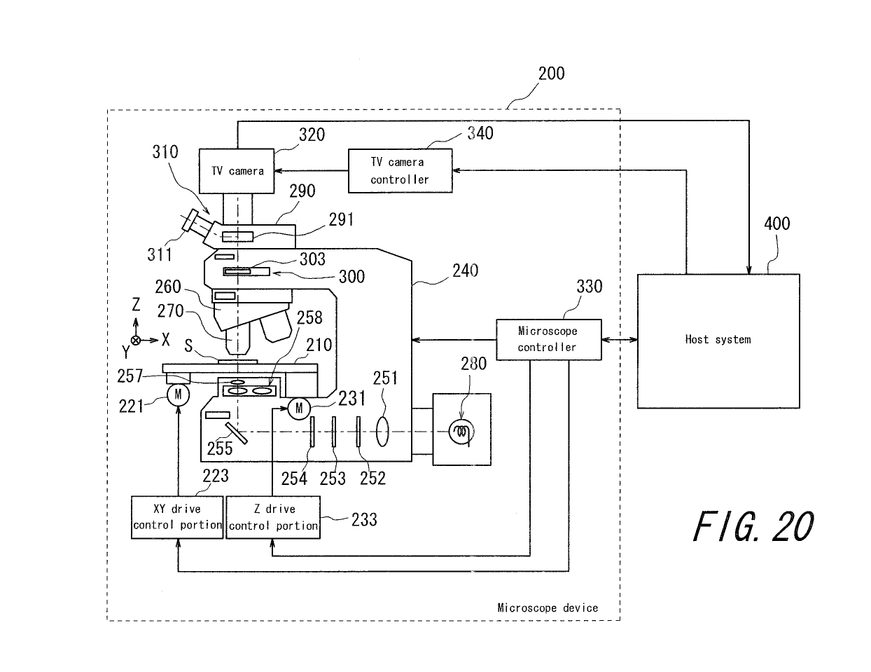

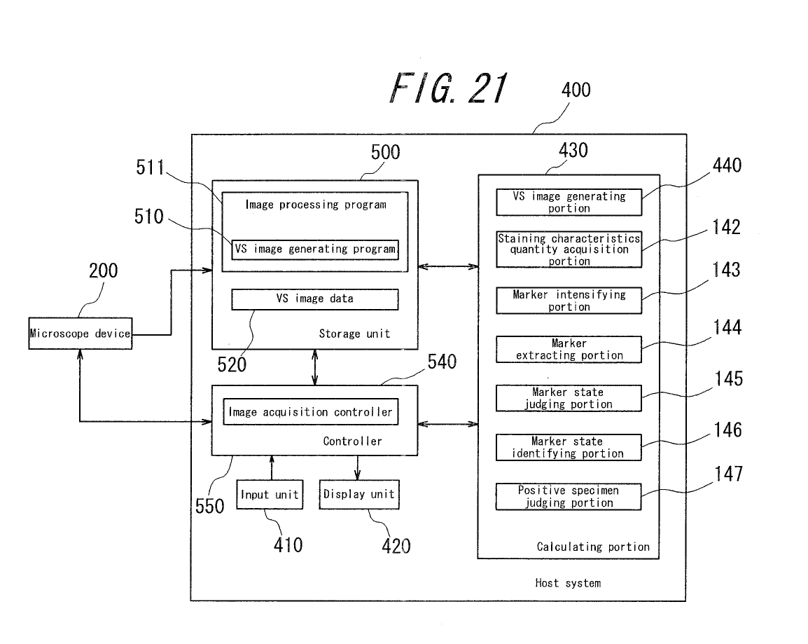

FIG. 20 and FIG. 21 are views showing a structure of the main parts of a virtual microscope system according to a fourth embodiment of the present invention. A microscope device 200 and a host system 400 are connected with each other so that data can be transmitted/received therebetween, thereby constituting the virtual microscope system. FIG. 20 shows a schematic structure of the microscope device 200 and FIG. 21 shows a schematic structure of the host system 400.

As shown in FIG. 20, the microscope device 200 includes: an electrically driven stage 210 on which a target specimen S is placed; a microscope body 240 having a lied down U-like shape in side view for supporting the electrically driven stage 210 and holding objective lens 270 (corresponding to the optical system 114 in FIG. 2) by way of a revolver 260; a light source 280 disposed at the rear bottom of the microscope body 240; and an optical column 290 placed at the upper portion of the microscope body 240. The optical column 290 are provided with a binocular portion 310 for visually observing a specimen image of a target specimen S and a TV camera 320 for photographing the specimen image of the target specimen S. the microscope device 200 corresponds to the image acquisition portion 110 of FIG. 1. In the present embodiment, the optical axis of the objective lens 270 shown in FIG. 20 is defined as the Z direction and the planes normal to the Z direction are defined as the X, Y plane.

The electrically driven stage 210 is structured to be movable in the X, Y, Z directions. Specifically, the electrically driven stage 210 is movable within the XY plane by a motor 221 and a XY drive control portion 223 for controlling drive of the motor 221. The XY drive control portion 223 detects the predetermined origin position in the XY plane of the electrically driven state 210 by a XY position origin sensor (not shown) under control of a microscope controller 330 and controls a drive magnitude of the motor 221, with the origin position as the base point, so that an observation point on a target specimen S is shifted. The XY drive control portion 223 outputs the X position and the Y position of the electrically driven stage 210 during observation to the microscope controller 330 in an appropriate manner.

The electrically driven stage 210 is movable in the Z direction by a motor 231 and a Z drive control portion 233 for controlling drive of the motor 231. The Z drive control portion 233 detects the predetermined origin position in the Z direction of the electrically driven state 210 by a Z position origin sensor (not shown) under control of a microscope controller 330 and controls a drive magnitude of the motor 231, with the origin position as the base point, so that the target specimen S is focus-adjustingly shifted to any Z position within a predetermined height range. The Z drive control portion 233 outputs the Z position of the electrically driven stage 210 during observation to the microscope controller 330 in an appropriate manner.

The revolver 260 is held rotatable relative to the microscope body 240 and disposes an objective lens 270 above the target specimen S. The objective lens 270 is detachably mounted on the revolver 260 together with other objective lenses having different (observation) magnification rates and shifted to be located on the optical path of observation light in accordance with rotation of the revolver 260, so that an objective lens 270 for use in observation of the target specimen S is selectively switched.

The microscope body 240 includes therein an illumination optical system for illuminating the target specimen S with transmitted light at the bottom portion thereof. The illumination optical system includes a collector lens 251 for collecting illumination light emitted from the light source 280, an illumination system filter unit 252, a field stop 253, an aperture stop 254, a fold mirror 255 for deflecting the optical path of the illumination light along the optical path of the objective lens 270, a condenser optical element unit 256, a top lens unit 257, and the like, disposed at appropriate positions along the optical path of illumination light. Illumination light emitted from the light source 280 is irradiated on the target specimen S by the illumination optical system and the transmitted light is incident on the objective lens 270 as observation light. Accordingly, the light source 280 and the illumination optical system correspond to the illumination portion 113 in FIG. 2.

Further, the microscope body 240 includes therein a filer unit 300 at the upper portion thereof. The filter unit 300 holds at least two optical filters 303 rotatable to restrict a wavelength of light to be imaged as a specimen image to a predetermined range. The optical filter 303 is moved to the optical path of observation light at a downstream position of the objective lens 270 in an appropriate manner. The filter unit 300 corresponds to the filter portion 115 shown in FIG. 2. Although a case where the optical filter 303 is disposed at a downstream position of the objective lens 270 is exemplified, the present embodiment is not restricted thereto and the optical filter 303 may be disposed at any position along the optical path from the light source 280 to the TV camera 320. The observation light through the objective lens 270 is incident on the optical column 290 via the filter unit 300.

The optical column 290 includes therein a beam splitter 291 for switching the optical path of the observation light from the filter unit 300 to introduce the light into the binocular portion 310 or the TV camera 320. A specimen image of the target specimen S is introduced into the binocular portion 310 by the beam splitter 291 and visually observed by an operator via an ocular lens 311. Alternatively, a specimen image of the target specimen S is photographed by the TV camera 320. The TV camera 320 is provided with an image pickup element such as a CCD, MOS for imaging a specimen image (specifically, a specimen image within the visual range of the objective lens 270), photographs a specimen image and outputs the image data of the specimen image to the host system 400. That is, the TV camera 320 corresponds to the RGB camera 111 shown in FIG. 2.

Further, the microscope 200 includes a microscope controller 330 and a TV camera controller 340. The microscope controller 330 comprehensively controls operations of the respective portions constituting the microscope device 200 under the control of the host system 400. For example, the microscope controller 330 carries out various adjustments of the respective portions of the microscope device 200 in association with observation of a target specimen S, which adjustments include: a process of rotating the revolver 260 to switch one objective lens 270 disposed on the optical path of observation light to another objective lens; light-adjusting control of the light source 280 in accordance with a magnification rate of the objective lens 270 thus switched, or the like; switching of various optical elements; instructions to the XY drive control portion 223 and/or the Z drive control portion 233 to move the electrically driven stage 210; and the like. The microscope controller 330 also notifies the host system 400 of the state of various portions.

The TV camera controller 340 drives the TV camera 320 by carrying out ON/OFF switching of automatic gain control, setting of gain, ON/OFF switching of automatic exposure control, setting of exposure time, and the like, under the control of the host system 400, thereby controlling the photographing operations of the TV camera 320.

The host system 400 includes an input portion 410, a display 420, a calculation portion 430, a storage portion 500, and a controller 540 for controlling various portions of the device, as shown in FIG. 21. The input portion 410 corresponds to the input portion 120 in FIG. 1 and the display portion 420 corresponds to the display portion 130 in FIG. 1. Although a functional structure of the host system 400 is shown in FIG. 21, the actual host system 400 can be realized by a known hardware structure including: a main storage device such as CPU, video board, main memory (RAM) and the like; an external storage device such as hard disc, various memory medium, and the like; a communication device; an output device such as a display device, a printing device and the like; an input device; an interface device for connecting various portions or effecting connection with an external input; and the like. For example, a general purpose computer such as a work station and a personal computer can be utilized as the host system.

The virtual microscope system according to the present embodiment has the function of the medical diagnosis support device of any of the first to third embodiments, and the calculation portion 430, the storage portion 500, and the controller 540 thereof correspond to the calculation portion 140, the storage portion 150, and the controller 150 in FIG. 1, respectively. Accordingly, the calculation portion 430 has a staining characteristics quantity acquisition portion 142, a marker intensifying portion 143, a marker extracting portion 144, a marker state judging portion 145, a marker state indentifying portion 146, and a positive specimen judging portion 147, which are similar to those in the first embodiment. Further, the calculation portion 430 includes a VS image generating portion 440. Regarding the calculation portion 430, it is acceptable to apply the structure of a modified example of the first embodiment thereto.

The VS image generating portion 440 generates a VS image by respectively processing plural target specimen images each obtained by the microscope device 200 multiband-photographing a part of a target specimen S. In the present embodiment, a VS image represents an image generated by patching at least one image obtained by multiband-photography by the microscope device 200, for example, an image generated by patching plural numbers of high-resolution images each obtained by photographing a part of a target specimen S by using a high magnification objective lens 270, which is a wide-field, high-definition multiband image reflecting the entire region of the target specimen S. In a case where the function of the medical diagnosis support device described in the third embodiment is to be realized, a VS image includes a wide-field, high definition multiband image generated at different depths of the target specimen S.

The storage portion 500 is realized by: various IC memory like a memory-updatable flush memory such as ROM or RAM; an information storage medium such as a CD-ROM and a hard disc installed or connected by way of a data communication terminal; and an information storage medium reading device. A program for operating the host system 400 to realize various functions provided in the host system 400, data for use when the program is executed, and the like are stored in the storage portion 500.

The storage portion 500 stores, for example, an image processing program 511 including a VS image generating program 510, and a VS image data (multiband image data) 520. The VS image generating program 510 is a program for realizing a process of generating a VS image of a target specimen S. Accordingly, as in the first embodiment described above, the image processing program 511 carries out intensification, extraction, judgment and the like, of a marker, whereby a marker state is identified and displayed in the display portion 420.

The control portion 540 is realized by hardware such as CPU and includes an image acquisition controller 550 for providing the respective portions of the microscope device 200 with operational instructions to photograph respective parts of a target specimen S to acquire a target specimen multiband image. The controller 540, for example, forwards instructions, effects transfer of data to the respective portions constituting the host system 400 or provides the respective portions of the microscope device 200 with operational instructions with respect to the microscope controller 330 and the TV camera controller 340, based on an input signal inputted from the input portion 410, the state of the respective portions of the microscope device 200 inputted from the microscope controller 330, image data inputted from the TV camera 320, the program and data stored in the storage portion 500, and the like, to comprehensively control the operations of the virtual microscope system as a whole.

According to the virtual microscope system of the present embodiment, due to the arrangement described above, there can be obtained an effect similar to the effect of the medical diagnosis support device of the foregoing embodiments.

### Fifth Embodiment

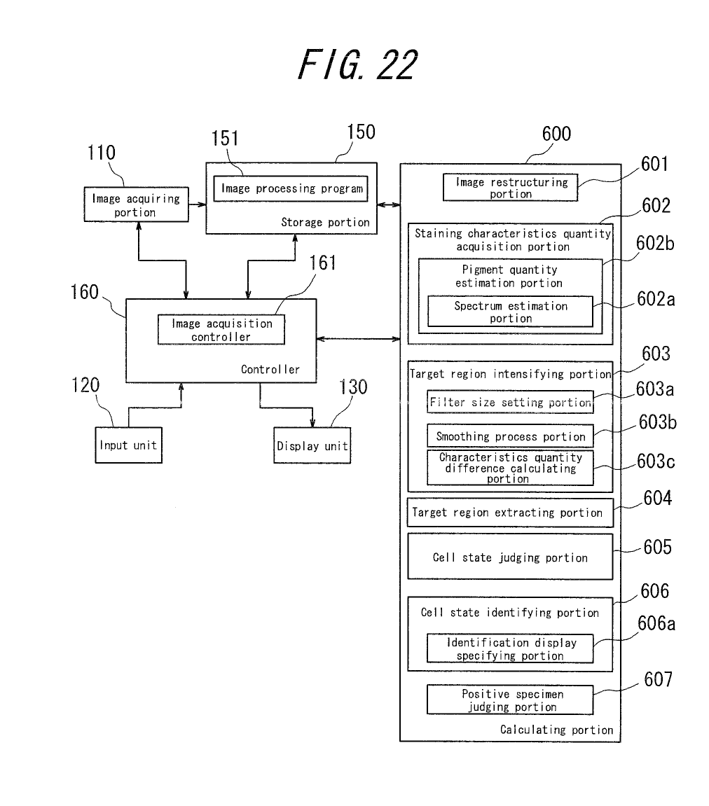

FIG. 22 is a block diagram showing a functional constitution of main parts of a medical diagnostics support device according to a fifth embodiment of the present invention. A calculation portion 600 of this medical diagnosis support device differs from the calculation portion 140 of the medical diagnosis support device shown in FIG. 1. Specifically, the calculation portion 600 includes an image restructuring portion 601, a staining characteristics quantity acquisition portion 602, a target region intensifying portion 603, an target region extracting portion 604, a cell state judging portion 605, a cell state identifying portion 606, and a positive specimen judging portion 607. The staining characteristics quantity acquisition portion 602 has a pigment quantity estimation portion 602b including a spectrum estimation portion 602a, as in FIG. 1. The target region intensifying portion 603 has a filter size setting portion 603a, a smoothing process portion 603b and a characteristic quantity difference calculation portion 603c. Further, the cell state identifying portion 606 has an identification display specifying portion 606a. Since other structures are the same as those in the first embodiment, the same reference numbers are assigned to the same components and detailed descriptions thereof will be omitted.

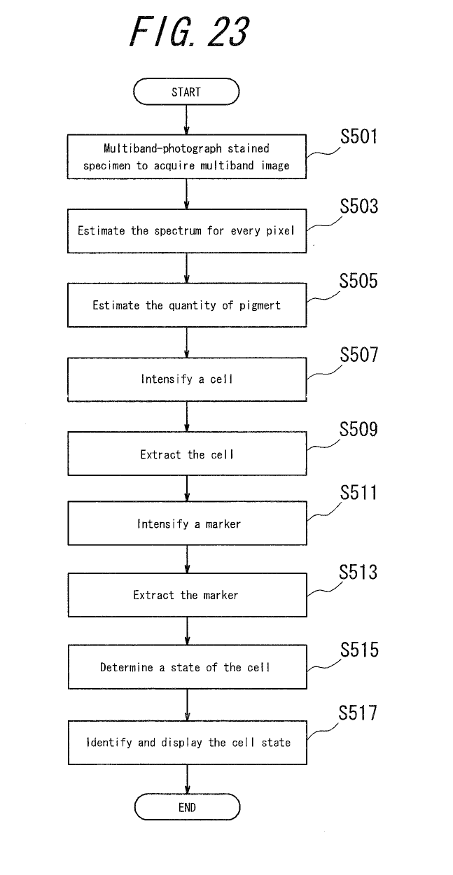

FIG. 23 is a flowchart schematically showing operations in the medical diagnosis support device of the present embodiment. First, the controller 160 controls the operations of the image acquisition portion 110 by the image acquisition controller 161 such that a target specimen S is multiband-photographed and target specimen images in respective bands are acquired as in the foregoing embodiments (step S501). Next, the controller 160 controls the staining characteristics quantity acquisition portion 602 to cause the spectrum estimation portion 602a to estimate spectrum (spectrum transmittance) of the target specimen, based on the pixel value of the target specimen image acquired at step S501 (step S503). Then, characteristics quantity (pigment quantity in the present embodiment) for generating each separate staining image of the target specimen is estimated, based on the estimation value of spectrum transmittance thus estimated (step S505).

Thereafter, the controller 160 causes the target region intensifying portion 603 to intensify the image of cells in the separate staining image, based on the pigment quantity of, for example, red (R) staining as one of the pigment quantities of the respective stainings estimated in step S505 (step S507). In this cell intensifying process, cell image is intensified based on the characteristics quantity of staining at a target pixel and the characteristics quantity of staining at pixels in the vicinity thereof, as in the marker intensifying process shown in FIG. 9. Specifically, two different filter sizes are set by the filter size setting portion 603a and the characteristics quantities of staining for the two filter sizes are respectively smoothed by the smoothing process portion 603b, so that difference between two characteristics quantities thus smoothing-processed is calculated by the characteristics quantity difference calculation portion 603c to intensify the cell images. In the present embodiment, one of the filter sizes set by the filter size setting portion 603a is set for only one, i.e. target pixel, while the other filter size is set at the same size as a cell.

Next, the controller 160 causes the target region extracting portion 604 to extract cells, based on comparison of the characteristics quantity of cells intensified by the target region intensifying portion 603 with a threshold value (step S509). The cell data thus extracted is stored in the storage portion 150.

When cells are intensified and extracted as described above, the controller 160 causes the target region intensifying portion 603 to intensify a marker of each staining based on the characteristics quantity (the pigment quantity in the present embodiment) estimated in step S503, as described in the first to third embodiments (step S511), and then causes the target region extracting portion 604 to extract each marker, based on comparison of the characteristics quantity of the marker of each staining intensified by the target region intensifying portion 603 with a threshold value (step S513. The marker data thus extracted is stored in the storage portion 150.

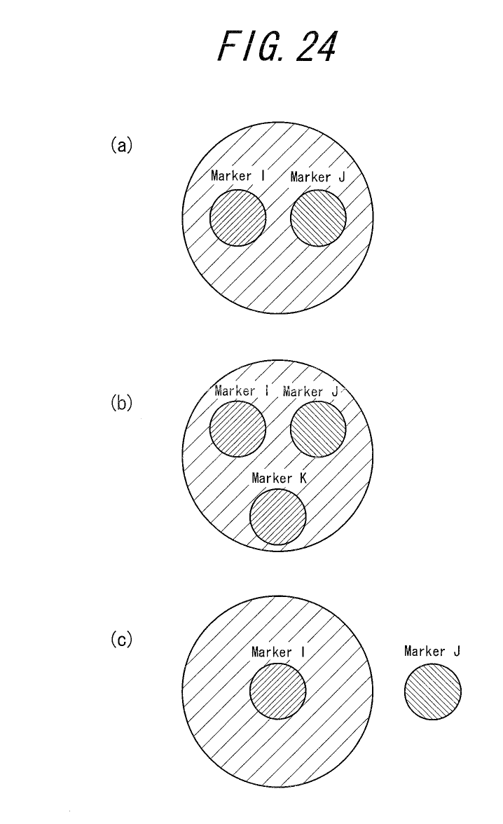

Thereafter, the controller 160 determines a cell state by the cell state judging portion 605 (step S515). In this cell state judging process, it is judged whether a cell state is negative or positive, based on the cell extracted in step S509 and the marker of each staining extracted in step S513. For example, it is judged that a cell state is negative when the marker number of one staining coincides with the marker number of the other staining in an extracted cell C as shown in FIG. 24(a), and it is judged that a cell state is positive when the marker number of one staining does not coincide with the marker number of the other staining in an extracted cell C as shown in FIG. 24(b) or FIG. 24(c). Further, depending on staining, it is judged that a cell state is negative when each of the marker numbers of different stainings in a cell is 1, while it is judged that a cell state is positive when each of the marker numbers of different stainings in a cell is not 1.

When the judgment process by the cell state judging portion 605 is completed, the controller 160 then causes the cell state identifying portion 606 to identify a cell state and display the cell state in the display portion 130 according to a display mode specified by the identification display specifying portion 606a (step S517). Accordingly, in the present embodiment, the cell state identifying portion 606 and the display portion 130 constitute the cell state identifying and display means. When the display mode is specified by the identification display specifying portion 606a, for example, “positive” button 171 and “negative” button 172 using graphical user interface (GUI) are displayed at the display 130 by the controller 160 as shown in FIG. 16, as in the foregoing embodiments, so that a user can select the desired button via the input portion 120.

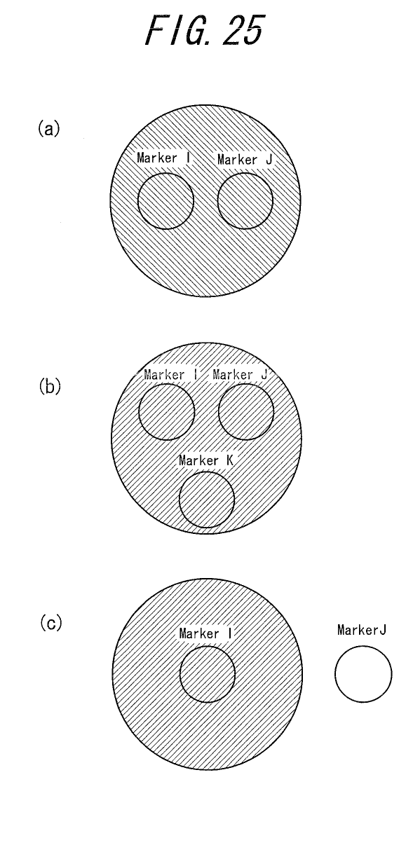

Then, for example, in a case where the “negative” button 172 has been selected, the negative display mode is specified and only negative cells are identified and displayed, as shown in FIG. 25(a). In a case where the “positive” button 171 has been selected, the positive display mode is specified and only positive cells are identified and displayed, as shown in FIG. 25(b) and FIG. 25(c). In a case where both the “negative” button 172 and the “positive” button 171 have been selected, the “all display” mode is specified and both of the negative cell and the positive cell are identified and displayed.

Then, the controller 160, according to necessity, causes the positive specimen judging portion 147 to determine whether the target specimen S is positive or negative, based on a ratio of the positive cells to the negative cells judged by the cell state judging portion 605, and stores the result in the storage portion 150. Alternatively, the positive degree of the specimen is stored as it is in the storage portion 150, as a reference value indicating the disease state of the target specimen S.

According to the medical diagnosis support device of the present embodiment, a “positive” or “negative” cell state of a cell having markers stained by

Dual CISH are identified and displayed, whereby a user such as a doctor can easily confirm whether the cell is positive or negative by his/her eyes. As a result, it is possible to easily and precisely determine chromosome abnormality and/or gene amplification related to cancer or genetic disease.

The present invention is not restricted to the aforementioned embodiments but various modifications or changes may be made thereto. For example, the present invention is not restricted to a specimen stained by Dual CISH but widely applicable to cases where a specimen stained by at least two types of staining methods is photographed with transmitted light and a stained image is displayed. Further, although a spectral characteristic value of spectrum transmittance is estimated from a multiband image obtained by photographing a stained specimen, in order to estimate pigment quantity of each staining in the foregoing embodiments, pigment quantity can be estimated by estimating a spectral characteristic value such as spectrum reflectivity, absorbance and the like. Yet further, although a multiband image with six bands is acquired for a stained specimen in the foregoing embodiments, it is acceptable to acquire characteristics quantity of each staining by acquiring any multiband image with four more bands or an image with three (RGB) bands.

Yet further, although at first a cell is intensified and extracted and then a marker is intensified and extracted in the fifth embodiment, it is acceptable to intensify and extract a marker first and then intensify and extract a cell in a reversed manner or simultaneously carry out the intensifying and extracting process of a cell and the intensifying and extracting process of a marker in a parallel manner. Yet further, it is acceptable to intensify a cell by using characteristics quantity other than staining and/or set in the intensifying process one of the two filter sizes in the filter size setting portion 603a at the same size as a marker, while setting the other filter size at the same size as a cell. Yet further, it is possible to apply the medical diagnosis support device described in the fifth embodiment to structure a virtual microscope system as described in the fourth embodiment.

Yet further, it should be noted that the present invention is not restricted to the medical diagnosis support device and the virtual microscope system described above but can be realized as an image processing method, an image processing program, and a storage medium having a program recorded therein for substantially carrying out the aforementioned processes and therefore includes them.

1. A medical diagnosis support device for acquiring information to support medical diagnosis from an image of a specimen stained by multiple staining, the image is obtained by photographing the stained specimen with transmitted light, the device comprising:
staining characteristics quantity acquisition means for acquiring characteristics quantity of each staining, based on a pixel value of the image of the stained specimen;
marker intensifying means for intensifying a marker, based on the characteristics quantity of each staining acquired by the staining characteristics quantity acquisition means;
marker extracting means for extracting the marker of each staining, based on the characteristics quantity in which the marker has been intensified by the marker intensifying means;
marker state judging means for judging a state of the marker, based on the marker of each staining extracted by the marker extracting means; and
marker state identifying and displaying means for identifying and displaying the marker state, based on the judgment result made by the marker state judging means.

2. The medical diagnosis support device of claim 1, wherein the marker state identifying and displaying means has identification display specifying means for specifying a display mode in which the marker state is identified and displayed, to identify and display the marker state as specified by the identification display specifying means.

3. The medical diagnosis support device of claim 2, wherein the identification display specifying means specifies a display mode selected from the group consisting of positive display mode for identifying and displaying only a positive marker state, negative display mode for identifying and displaying only a negative marker state, and all display mode for identifying and displaying both a positive marker state and a negative marker state.

4. The medical diagnosis support device of claim 3, wherein the marker state identifying and displaying means displays a positive marker state and a negative marker state with different colors, respectively, in the all display mode.

5. The medical diagnosis support device of claim 3, wherein the marker state identifying and displaying means displays superposed portions of markers of each staining in a negative marker state with a different color in the all display mode.

6. The medical diagnosis support device of claim 1, wherein the staining characteristics quantity acquisition means acquires characteristics quantity of each staining, based on a pixel value of a stained specimen image restructured from plural images photographed at different depth.

7. The medical diagnosis support device of claim 6, wherein the stained specimen image thus restructured is a focused image obtained by patching focused pixels in respective regions, taken from plural images photographed at different depths.

8. The medical diagnosis support device of claim 1, wherein the staining characteristics quantity acquisition means has pigment quantity estimation means for estimating pigment quantity based on a pixel value of the stained specimen image and acquires the pigment quantity estimated by the pigment quantity estimation means as characteristics quantity of said each staining.

9. The medical diagnosis support device of claim 8, wherein the pigment quantity estimation means has spectrum estimation means for estimating spectrum from a pixel value of the stained specimen image and estimates pigment quantity, based on the spectrum estimated by the spectrum estimation means.

10. The medical diagnosis support device of claim 1, wherein the staining characteristics quantity acquisition means acquires, as characteristics quantity of each staining, a pixel value of a stained specimen image photographed with illumination light having a corresponding wavelength range.

11. The medical diagnosis support device of claim 1, wherein the marker intensifying means intensifies a marker, based on characteristics quantity of staining at a target pixel and characteristics quantity of staining at a pixel in the vicinity thereof.

12. The medical diagnosis support device of claim 11, wherein the marker intensifying means has:
filter size setting means for setting two different filter sizes;
smoothing process means for smoothing the characteristics quantity of each staining, based on the two filter sizes set by the filter size setting means;
characteristic quantity difference calculation means for calculating difference between the two characteristics quantities calculated by the smoothing process means.

13. The medical diagnosis support device of claim 12, wherein the filter size setting means sets one of the two filter sizes at 1.

14. The medical diagnosis support device of claim 13, wherein the filter size setting means sets the other of the two filter sizes at the same size as a marker.

15. The medical diagnosis support device of claim 12, wherein the filter size setting means adjusts at least one of the filter sizes according to a magnification rate at which the specimen is photographed.

16. The medical diagnosis support device of claim 1, wherein the marker intensifying means intensifies a marker by subjecting the characteristics quantity of each staining acquired by the staining characteristics quantity acquisition means to an edge intensifying process.

17. The medical diagnosis support device of claim 1, wherein the marker extracting means extracts a maker, based on a first threshold value, from the characteristics quantity in which the marker has been intensified by the marker intensifying means.

18. The medical diagnosis support device of claim 1, wherein the marker extracting means extracts a maker from the characteristics quantity in which the marker has been intensified by the marker intensifying means, by filtering an area indicating a morphology of the marker.

19. The medical diagnosis support device of claim 1, wherein the marker extracting means extracts a maker from the characteristics quantity in which the marker has been intensified by the marker intensifying means, by filtering circularity indicating a morphology of the marker.

20. The medical diagnosis support device of claim 1, wherein the marker state judging means has means for calculating characteristics quantity between markers, for calculating characteristics quantity between markers of different stainings based on the marker of each staining extracted by the marker extracting means and determines a marker state, based on the characteristics quantity between markers calculated by the means for calculating characteristics quantity between markers.

21. The medical diagnosis support device of claim 20, wherein the means for calculating characteristics quantity between markers calculates distance between centers of gravity of markers of different stainings, as the characteristics quantity between markers.

22. The medical diagnosis support device of claim 20, wherein the means for calculating characteristics quantity between markers calculates, as the characteristics quantity between markers, a ratio of an area where a marker of one staining is superposed with a marker of another staining to an area where the marker of one staining is not superposed with the marker of another staining.

23. The medical diagnosis support device of claim 20, wherein the means for calculating characteristics quantity between markers calculates, as the characteristics quantity between markers, distance between centers of gravity of markers of different stainings at different depths.

24. The medical diagnosis support device of any of claim 20, wherein the marker state judging means judges that a marker state is normal when the characteristics quantities between markers satisfy a second threshold value.

25. The medical diagnosis support device of claim 24, wherein the marker state judging means judges that a marker is translocation when characteristics quantities between a marker of one staining and every marker of another staining fail to satisfy the second threshold value.

26. The medical diagnosis support device of claim 20, wherein, when characteristics quantities between a marker of one staining and at least two markers of another staining satisfy a third threshold value, the marker state judging means judges that the two markers, having characteristics quantity therebetween maximally satisfying the third threshold value, are normal and that other markers are translocation eases.

27. The medical diagnosis support device of claim 26, wherein, when characteristics quantities between a marker of one staining and every marker of another staining fail to satisfy the third threshold value, the marker state judging means judges that the marker of one staining is a translocation case.

28. The medical diagnosis support device of claim 24, wherein the marker state judging means adjusts the second threshold value in accordance with a magnification rate at which the specimen is photographed.

29. The medical diagnosis support device of claim 26, wherein the marker state judging means adjusts the third threshold value in accordance with a magnification rate at which the specimen is photographed.

30. The medical diagnosis support device of claim 1, wherein the marker state judging means has positive marker judging means for judging that a marker state where markers of two stainings are superposed on each other is negative and a marker state where no superposition is observed between the two stainings is positive.

31. The medical diagnosis support device of claim 1, further comprising positive specimen judging means for judging that the specimen is positive, based on the marker of each staining extracted by the marker extracting means.

32. The medical diagnosis support device of claim 31, wherein the positive specimen judging means judges that the specimen is positive based on a ratio of a pixel of a marker of one staining, which pixel is superposed with a pixel of a marker of another staining, with respect to pixels of all the markers of the one staining

33. The medical diagnosis support device of claim 1, further comprising positive specimen judging means for judging that the specimen is positive, based on the judgment result made by the marker state judging means.

34. The medical diagnosis support device of claim 33, wherein the positive specimen judging means judges that the specimen is positive, based on a ratio of a negative marker state where markers of two stainings are superposed on each other, to a positive marker state where superposition of markers of two stainings is not observed.

35. An image processing method for acquiring information to support medical diagnosis from an image of a specimen stained by multiple staining, the image is obtained by photographing the stained specimen with transmitted light, the method comprising the steps of:
acquiring characteristics quantity of each staining, based on a pixel value of the image of the stained specimen;
intensifying a marker, based on the characteristics quantity of each staining thus acquired;
extracting the marker of each staining, based on the characteristics quantity in which the marker has been thus intensified;
judging a state of the marker, based on the marker of each staining thus extracted; and
identifying and displaying the marker state, based on the judgment result.

36. An image processing program for acquiring information to support medical diagnosis from an image of a specimen stained by multiple staining, the image is obtained by photographing the stained specimen with transmitted light, the program making a computer execute the processes of:
acquiring characteristics quantity of each staining, based on a pixel value of the image of the stained specimen;
intensifying a marker, based on the characteristics quantity of each staining thus acquired;
extracting the marker of each staining, based on the characteristics quantity in which the marker has been thus intensified;
judging a state of the marker, based on the marker of each staining thus extracted; and
identifying and displaying the marker state, based on the judgment result.

37. A virtual microscope system for acquiring information to support medical diagnosis from an image of a specimen stained by multiple staining, the system comprising:
image acquiring means for acquiring an image of the stained specimen by photographing the stained specimen with transmitted light by using a microscope;
staining characteristics quantity acquisition means for acquiring characteristics quantity of each staining, based on a pixel value of the image of the stained specimen acquired by the image acquiring means;
marker intensifying means for intensifying a marker, based on the characteristics quantity of each staining acquired by the staining characteristics quantity acquisition means;
marker extracting means for extracting the marker of each staining, based on the characteristics quantity in which the marker has been intensified by the marker intensifying means;
marker state judging means for judging a state of the marker, based on the marker of each staining extracted by the marker extracting means; and
marker state identifying and displaying means for identifying and displaying the marker state, based on the judgment result made by the marker state judging means.

38. A medical diagnosis support device for acquiring information to support medical diagnosis from an image of a specimen stained by multiple staining, the image is obtained by photographing the stained specimen with transmitted light, the device comprising:
target region intensifying means for intensifying a marker and a cell, respectively, based on a pixel value of the image of the stained specimen;
target region extracting means for extracting the marker and the cell intensified by the target region intensifying means;
cell state judging means for judging a cell state of the cell extracted by the target region extracting means, based on the marker extracted by the target region extracting means; and
cell state identifying and displaying means for identifying and displaying the cell state, based on the judgment result made by the cell state judging means.

39. The medical diagnosis support device of claim 38, wherein the marker intensifying means intensifies a marker, based on characteristics quantity of staining at a target pixel and characteristics quantity of staining at a pixel in the vicinity thereof.

40. The medical diagnosis support device of claim 39, wherein the marker intensifying means has:
filter size setting means for setting two different filter sizes;
smoothing process means for smoothing the characteristics quantity of each staining, based on the two filter sizes set by the filter size setting means;
characteristic quantity difference calculation means for calculating difference between the two characteristics quantities calculated by the smoothing process means.

41. The medical diagnosis support device of claim 40, wherein the filter size setting means sets one of the two filter sizes at the same size as a marker and sets the other of the two filter sizes at the same size as a cell.

42. The medical diagnosis support device of claim 38, wherein the cell state judging means judges a cell state, based on the number of markers of different stainings contained in a cell.

43. The medical diagnosis support device of claim 42, wherein the cell state judging means judges that a cell state is negative when the marker number of one staining coincides with the marker number of the other staining.

44. The medical diagnosis support device of claim 42, wherein the cell state judging means judges that a cell state is positive when the marker number of one staining does not coincide with the marker number of the other staining.

45. The medical diagnosis support device of claim 42, wherein the cell state judging means judges that a cell state is negative when each of the marker numbers of different stainings in the cell is 1.

46. The medical diagnosis support device of claim 42, wherein the cell state judging means judges that a cell state is positive when each of the marker numbers of different stainings in the cell is not 1.

47. The medical diagnosis support device of claim 38, wherein the cell state identifying and displaying means has identification display specifying means for specifying a display mode in which the cell state is identified and displayed, to identify and display the cell state as specified by the identification display specifying means.

48. An image processing method of acquiring information to support medical diagnosis from an image of a specimen stained by multiple staining, the image is obtained by photographing the stained specimen with transmitted light, the method comprising the steps of:
acquiring characteristics quantity of each staining, based on a pixel value of the image of the stained specimen;
intensifying a cell, based on the characteristics quantity of each staining thus acquired;
extracting the cell, based on the characteristics quantity in which the cell has been thus intensified;
intensifying a marker, based on the characteristics quantity of each staining thus acquired;
extracting the marker of each staining, based on the characteristics quantity in which the marker has been thus intensified;
judging a cell state of the extracted cell, based on the extracted marker; and
identifying and displaying the cell state, based on the judgment result.

49. An image processing program for acquiring information to support medical diagnosis from an image of a specimen stained by multiple staining, the image is obtained by photographing the stained specimen with transmitted light, the program making a computer execute the processes of:
acquiring characteristics quantity of each staining, based on a pixel value of the image of the stained specimen;
intensifying a marker and a cell, respectively, based on the characteristics quantity of each staining thus acquired;
extracting the marker and the cell, respectively, based on the characteristics quantities thereof in which the marker and the cell have been intensified, respectively;
judging a cell state of the extracted cell, based on the extracted marker; and
identifying and displaying the cell state, based on the judgment result.

50. An virtual microscope system for acquiring information to support medical diagnosis from a specimen stained by multiple staining, the system comprises:
image acquiring means for acquiring an image of the stained specimen by photographing the stained specimen with transmitted light by using a microscope;
staining characteristics quantity acquisition means for acquiring characteristics quantity of each staining, based on a pixel value of the image of the stained specimen acquired by the image acquiring means;
target region intensifying means for intensifying a marker and a cell, respectively, based on the characteristics quantity of each staining acquired by the staining characteristics quantity acquisition means;
target region extracting means for extracting the marker and the cell, respectively, based on the characteristics quantities thereof in which the marker and the cell have been intensified by the target region marker intensifying means;
cell state judging means for judging a cell state of the cell extracted by the target region extracting means, based on the marker extracted by the target region extracting means; and
cell state identifying and displaying means for identifying and displaying the marker cell state, based on the judgment result made by the cell state judging means.
